(19) United States
(12) Patent Application Publication
(10) Pub. No.: US 2013/0166405 A1
(43) Pub. Date: Jun. 27, 2013

(54) GOLF CLUB COVER WITH VOID OR INSERT

(71) Applicants: Steven M. Mitzel, Carlsbad, CA (US); Austin B. Oliveiro, San Marcos, CA (US); Douglas E. Roberts, Carlsbad, CA (US); Peter L. Soracco, Carlsbad, CA (US)

(72) Inventors: Steven M. Mitzel, Carlsbad, CA (US); Austin B. Oliveiro, San Marcos, CA (US); Douglas E. Roberts, Carlsbad, CA (US); Peter L. Soracco, Carlsbad, CA (US)

(73) Assignee: COBRA GOLF INCORPORATED, CARLSBAD, CA (US)

(21) Appl. No.: 13/477,661

(22) Filed: May 22, 2012

Related U.S. Application Data
(63) Continuation-in-part of application No. 13/335,007, filed on Dec. 22, 2011.

(51) Int. Cl. A63B 57/00; G06Q 30/00

(52) U.S. Cl. 705/26.5; 150/160

(57) ABSTRACT

A cover for a golf club is provided having a see-through panel. A club head cover with a see-through panel provides beneficial ease of use in the form of a view of the covered club while protecting the club from dirt, moisture, and damage. A head cover with a see-through panel can be manufactured affordably and include environmentally friendly “green” plastics. A cover further includes optional voids or plastic inserts to optimize flexibility, rigidness, and ease of gripping.

### CROSS-REFERENCE TO RELATED APPLICATIONS

This application is a continuation-in-part of U.S. patent application Ser. No. 13/335,007, filed Dec. 22, 2011, the contents of which are incorporated by reference herein in their entirety.

### FIELD OF THE INVENTION

The invention relates to covers for golf club heads.

### BACKGROUND

Golf club head covers are used to protect and store golf clubs. Covers keep dirt and grime off of clubs, and prevent scratching and marring of the surfaces. There are loose-fitting, sock-type covers as well as fitted covers made from stiff materials that define a three-dimensional shape to enclose a golf club head.

Some golfers experience annoyance with their covers. For instance, a cover hides which club is being covered. If a wet club is covered, it dries slowly, resulting in mildew and bad odors. Further, golfers may desire products with environmentally-friendly designs that incorporate fewer chemicals, less materials, and sustainable components.

Sock-type covers offer only limited protection from impact. Such covers tend to impart a skimpy and cheap appearance. They are also unable to maintain their form upon removal from a club head and are therefore less appealing than a fitted head cover.

Fitted covers are difficult to put on and take off, particularly when made with stiffer materials such as neoprene, leather, vinyl, and the like. A rigid material resists the folding and deformation necessary for the large head of a driver-type club to be removed.

Adding a handle is not an optimum solution. Adding another component to a product requires additional material, steps, and cost in manufacturing. Some methods of attaching a handle involve chemical glues that can be bad for the environment. Additional components also increase product weight, thereby increasing shipping costs and fuel consumption. Also, some golfers do not like the appearance of a handle protruding from what would otherwise be a streamlined and attractive cover.

### SUMMARY

The invention provides a cover for a golf club having a see-through panel in the material allowing for a view of the golf club. The see-through panel can provide an extended viewing area optionally in conjunction with one or more of a void or fully transparent window, giving a golfer a good view of the club. Since a see-through panel can be provided by a plastic, the panel can add useful rigidity to selected portions of the cover, better protecting the clubs. Further, a see-through panel can be provided by an environmentally-friendly “green” plastic, such as one that uses recycled materials or one that is degradable.

In certain aspects, the invention provides a cover for a golf club that includes at least one piece of material shaped to define a head region and materially connected to a first end of a sleeve member, the sleeve member having an opening at a second end. The cover is configured to receive a golf club and it includes least one see-through panel.

A see-through panel in a golf club head cover allows a golfer to view the contents. A golfer can see at a glance which club is covered. Modern golf clubs sometimes include an adjustment mechanism for an adjustable setting and a see-through panel allows a golfer to view an effective setting of the adjustment mechanism. A see-through panel allows a golf club designer to design a club and a cover together for visual harmony—a logo or visible design detail of the club can be configured to be visible through the see-through panel. Further, some covers include one or more voids, or holes through the surface, through which the covered club can be seen and even touched. A hole can be big enough to put a finger through (e.g., at least about 1 cm²) to provide visual interest and even big enough to provide a handle (e.g., at least about 5 cm²) to allow for easy removal of the cover. A see-through panel allows the viewable area to be increased without increasing the area of the covered club that is exposed to the elements (e.g., a panel of see-through material can be, for example, at least about 3 cm²). A cover can include more than one see-through panel. For example, a cover can include any see-through panel described herein (e.g., a translucent panel of extruded plastic with a textured mesh-like surface) as well as a clear window (e.g., a vinyl window over the crown area of the cover). This allows a cover designer to provide generous viewing area of the covered club while still optimizing protection and rigidity as well as giving a desired amount of cover flexibility. For example, a designer can provide a soft vinyl clear window and a somewhat rigid translucent or transparent plastic see-through panel. In certain embodiments, the see-through panel includes a translucent material and a window area includes transparent material, mesh (e.g., a shear polyester mesh material), or web (e.g., soccer-ball net).

The see-through panel can be provided by a polymer such as a plastic or a cellulose-based polymer. The panel material can be translucent, transparent, or opaque. A see-through panel of opaque material is provided by structure such as a lattice, mesh, net, or similar. Surfaces of the panel can be smooth or textured. Textures can be irregular (e.g., pebbled, brush-strokes, stippled) or regular patterns. For example, a textured surface can include pattern that appears mesh-like, and can even mimic an region of mesh material elsewhere on the club head cover. A texture can include any regular repeating pattern, such as a geometric patterns (squares, hexagons, rectangles), repeating marks (logos, words, etc., embossed in the material), or fanciful patterns (e.g., Escher lizards).

In certain embodiments, a cover includes a see-through panel as well as one or more additional panels. For example, a cover can include a first material for the predominant head area, a second material for the sleeve that covers the shaft of a club, a third material for the see-through panel, and an insert panel of a fourth material.

The insert panel may be opaque or translucent. It may share in any of the properties of the see-through panel: material, transparency, surface finish, color, etc. Insert panels may include a polymer-based material, a synthetic material, a natural material such as leather, paper fibers such as a cardboard (e.g., with a slick finish), rubber, fabric, or any other material.

Use of plastic panels provides rigidity and allows environmentally-friendly materials to be used. Plastics or other polymers including, for example, cellulose-based polymers can include recycled materials or degradable materials such as biodegradable or photodegradable materials.

Plastic panels allow for selective removal of patterns of material from a surface to provide panels of material that are lighter than panels with smooth surfaces. Material can be removed in a cell pattern or similar. A cell pattern can include cells, where cells are portions of material removed from a surface of a material to create hollows or divots. A cell can have straight-down walls, angled-in walls, cutaway walls, or irregular walls. A cell is generally a recessed space in a surface, protruding into the material (i.e., a recessed opening). A cell pattern includes one or more cells. Cells in a pattern can be similar in size, shape, or both, and can be arranged in a repeating pattern. For example, cells can have a shape that can be tessellated, such as rectangle or hexagon, and can be tessellated together on the surface of the material.

Selective removal of cells of material can decrease the weight of the material without substantially decreasing the strength or rigidity. Cell size and depth can be optimized to provide a material that is lightweight, strong, and has a desired rigidity. Sheets of material with cell patterns function as though they were the same thickness as smooth sheets of material. They prevent impacts and protect materials as well as, or better than, smooth sheets of material of functionally equivalent thickness. Cell-surfaced materials can exhibit greater springiness and resistance to bending or deformation than expected, while being surprisingly light. Plastic extrusion techniques, molding, and embossing, for example, provide inexpensive methods for manufacturing cell-surfaced material.

In certain embodiments, each cell is a hole through more than about 10% of the thickness of the material. Greater weight savings are had by deeper cells so, in some embodiments, each cell is a hole through more than about 25% of the thickness of the material (e.g., more than about 50% of the thickness). In very light-weight embodiments, each cell is a hole through more than about 75% of the thickness of the material. In strength-optimized (e.g., puncture and tear resistant), each cell is a hole through about 30% to about 70% of the thickness of the material.

The invention further provides a golf club cover that includes one or more accessory. Since golfers often have their club covers near them during golf and the club covers can be a relatively inexpensive accessory, the cover is good target for modification by addition of accessories. The invention includes any of a number of functional accessories, for example, any that a golfer may desire access to during a game of golf. Accessories can include a fastener such as a clip or strap for attaching another accessory; a storage pocket (e.g., for tees or a cell phone); a bottle opener; a cigar cutter; a light (e.g., a safety LED or a flashlight); a removable pouch; an electronic device (e.g., a shot-tracking device); a knife; a multi-tool; and printed matter (e.g., an instruction manual for a shot-tracking device or smartphone app, or an ID tag). In some embodiments, the functional accessory is a removable accessory, such as a storage pouch (e.g., zippered pouch or snap-case). In certain embodiments, a cover includes a bottle opener, for example, either connected by a lanyard or integrated into the material. The space under the “chin” of the cover provides a good location for a bottle opener based on its orientation in space when the cover is in use in a golf bag.

In certain aspects, the invention provides a cover for a golf club that includes material shaped to define a right cheek area, a left cheek area, a crown area, a chin area, a nape area, and a sleeve area. The cover has an opening configured to receive a golf club head-first and one or more panels of see-through material. In some embodiments, the main material is inelastic, the sleeve is generally elastic, and the see-through material is plastic. Additionally, the cover can include one or more opaque insert panels. The opaque panel and/or the see-through panel can have a pattern, such as a visible or textured pattern on the surface. In some embodiments, either panel includes a pattern of cells.

In certain embodiments, a cover includes a void in the material allowing some deformation, thus making a stiff-material cover easy to put on and take off. One or more voids further provide a convenient handle as well as a view of the covered club and ease of drying of the inside. By providing a void, for example, as a cutaway in a panel of material from which a cover is assembled, manufacturing is simplified, minimizing costs.

The cover of the invention provides good protection of a golf club. The cover avoids a protruding pull-tab or external dongle, thereby avoiding excessive clutter in a golf bag and presenting one less thing to get snagged on, for example, metal parts of a car trunk lid or other environmental clutter. Head covers according to the invention avoid additional tabs, straps, or other parts that may need to be cemented on with environmentally harmful chemical glues. Covers of the invention avoid additional straps or tabs of material that need to be stitched on, for example, by hand, thereby decreasing labor demand and assembly complexity.

A void in a cover allows a golfer to see what club is covered. One or more voids can optionally be filled with a see-through material to provide visibility while protecting the club. For example, a void can be positioned to reveal a manufacturer's logo to provide the functional benefit of aiding a golfer pick the right club from a bag. A void can be positioned to allow a golfer to see an adjustable setting mechanism on a club head or similar.

Two voids can be placed such that a bridge-like strap of material separates them and provides a comfortable handle for gripping the cover. By providing voids, a strap-like handle can thus be provided without requiring additional material during manufacturing.

A void can be provided that supplies any of the functional advantages here, and further supplies design advantages. A void can engage a viewer by mimicking or subtly suggesting the appearance of, for example, nostrils or eyes. A void can be designed in harmony with a design of a company's logo on their golf clubs as an aesthetic, design, or marketing benefit. For example, a void can be positioned to reveal or accentuate the appearance of a portion of a covered club.

A void can be provided that supplies a seed region for folding or deformation. When a cover is pulled on to or off of a club head, as the large club head pushes past the narrower neck, material of the head smoothly rearranges itself without creasing across panels of the material. A cover can be made incorporating a resilient material, such as a corrugated material, that deforms and returns to its original shape. A resilient material and a void can cooperatively contribute to good deformation resilience, thereby enhancing and prolonging the usefulness and attractiveness of a cover.

A void can further provide a convenient place for a tether to either pass through the cover or reach to the club head. A tether can keep a cover from flying away when a golf bag is in the back seat of an open convertible out on the highway. A cover of the invention can include a tether, such as a nylon or hemp cord, either attached to the cover at one end, integrally formed with the cover, or configured to be passed through a void. A tether can have a clip, loop, or other mechanism or feature at either end for attaching, for instance, to a co-designed golf bag. A tether can be designed in harmony with a cover, continuing a line of material pattern or sharing a color with the cover, and offer the desirable benefit of keeping the cover with a golf cart or golf bag.

In certain aspects, the invention provides a cover for a golf club made from at least one piece of material shaped to define a head region. The head region is materially connected to a sleeve member, which has an opening at a bottom end. The head region can generally be described as having a crown area, a left cheek area, a right cheek area, a snout area, a chin area, and a nape area. The head region transitions to the sleeve member through a throat area. The sleeve member terminates at a distal (e.g., the bottom end) end at a cuff area defining the opening.

The cover is configured to receive a golf club so that the head of the club sits within the head region, and the shaft of the club protrudes from the opening. The cover has at least one void through the piece of material. As with the opening, from which the shaft protrudes, the void is an opening through the material and thus provides a spatial connection between the space outside of the cover and the space inside.

A cover of the invention can include one or more panels of material assembled together. For example, a cover can be made by cutting panels having a particular shape, for instance according to a pattern. The panels can be joined at edges to form seams. A void can be supplied by cutting away material from a panel of material before or during assembly. In some embodiments, a void is provided in the form of a cutaway, for instance, abutting an edge of a panel. In this manner, a void can be provided by cutting into a panel from an edge rather than cutting a hole through a panel—although either embodiment, as well as others, are contemplated by the invention. When a void is defined by cutting into a panel from the edge, a result can be that, after assembly, one edge of the void is provided by the cut edge of that panel, and another edge of the void is provided by another edge of material (e.g., a distal edge of the same panel or an edge of another panel). As a result, an edge of the void and an adjacent portion of the seam can define a line that is substantially straight or a substantially smooth curve. In some embodiments, a portion of a seam and an edge of a void together define a line having no visible points or visible inflexion points.

In some embodiments, a void is provided in the form of a cutout, such as would be made by a cookie cutter. A cutout, generally, provides a hole cut through a piece of material such that the perimeter of the void is all of one contiguous piece of material.

Two voids can be included in a cover. The two voids can be positioned near each other. Two voids can present two edges that are substantially parallel for a distance and a distance apart such that the material between them takes a form of a strap or a bridge of material. While not being limited to a perfectly rectangular geometry, a bridge of material can be described in terms of a length and a width. A width of a bridge can be between about half an inch and about three inches. A length of a bridge can be between about two inches and about six inches. In some embodiments, a length of a bridge is between about one inch and about ten inches. In some embodiments, length of a bridge is between about four inches and about seven inches. In some embodiments, a length of a bridge is between about three and about five inches.

Two voids can be provided that are symmetrically opposed to each other in shape, size, and disposition.

By including a void, a cover according to the invention provides environmental benefits. The void itself decreases the amount of material used. Where a piece of material is cutaway during manufacturing, that piece can be used elsewhere, for example, to provide an accessory pocket on a surface of the cover, or to make a useful golf accessory such as a floating key fob. Where a cover is made from a synthetic material such as neoprene—or assembled from smaller pieces, such as panels of leather—less total material can be consumed, supporting an Earth-friendly view of the cover. A void further decreases an amount of material used in a cover by avoiding the need to add additional material to form a handle or pull-tab. Where a cover employs a stocking design, the need for Velcro or magnets (and cement to hold it them place) for a closure is avoided. Beyond just savings in material resource consumption, material savings translate into further environmental benefits. By decreasing a weight of a cover, even by an ounce, a case of a gross of covers is made 9 pounds lighter. Thus a palate of cases can be shipped with significantly lower weight, cost, and fuel consumption.

In some embodiments, a cover includes a window. A window can be a void or a void having a see-through material filling it all or in-part. For example, a cover of the invention can have an open void in one place and a void comprising a see-through material in another place. A see through material can be a mesh, a net, a clear transparent material, a translucent material, a web, or a scrim. In certain embodiments, a cover has two open voids defining a bridge and a window filled with a see-through material. In some embodiments, the bridge is generally along the nape area of the cover and the window is an inset in the crown area of the cover.

A void can be described in terms of size. One way to describe the size is by the minimum amount of a two-dimensional inelastic material that it would take to cover the void. A minimum amount of material necessary to close the void can be between about 3 cm² and about 75 cm². In some embodiments, it is desired that a minimum amount of material necessary to close the void is between about 25 cm² and about 60 cm². A void can be provided that is generally approximately the size to allow one adult finger to be inserted therein. In some embodiments, two adult fingers fit through a void. In certain embodiments, a void is sized to allow an adult had, up to a base of a thumb, to be inserted therein. In certain embodiments, an edge of a void is finished. An edge of a void can be finished with a seam, for example, stitched, fused, or cemented. An edge can be finished with a grommet. In some embodiments a circular void is provided. In some embodiments, a circular void is provided ringed with a grommet, for example, a metal or plastic grommet.

In certain aspects, the invention provides a cover for a golf club including material disposed to define a right cheek area, a left cheek area, a crown area, a chin area, a nape area, and a sleeve area with an opening configured to receive a golf club head-first and at least one void through the material. The cover can include a second void.

A void of the invention can be described in terms of its shape. A void can have a shape with an irregular geometry. A void can have a shape that mimics or suggests some other objects (e.g., an eye, a miniature golf club, a rocket ship, a snake, a star, etc.). A shape of a void can be elongated, including either precisely or generally rectangular, oblong, elliptical, or round. An elongated void can be described in terms of a ratio of a length to width. A length or a width can refer to either a predominant, average, or maximum length or a width, or can refer to a length or a width at specific point, such as a center. For example, a length can be measured at the middle of a width while a width is measured at a middle of a length. A length and width can be measured on a rectangle defined as having a same area of a void and located to have maximum overlap with the void. In some embodiments, a void has a length greater than a width, e.g., greater than about 110% or 125% of a width. In some embodiments, void has a length that is more than about 150% of its length, or optionally a length more than double a width.

A void of the invention can be near, or abutting, the nape area. In certain embodiments, two voids abut the nape, such that the nape defines a bridge of material. In some embodiments, the cover includes a window of transparent material, translucent material, mesh, web, or void space. The window can optionally be provided in the crown area.

A cover of the invention can generally include, but is not limited to, an elastic material in the sleeve area and a non-elastic material in the crown area and the nape area. One suitable elastic material includes spandex or a knit fabric, for example, knit acrylic or polyester. In some embodiments, an area of the cover is two-ply or reinforced, for example, a bridge area or an area along an edge of a void.

In certain aspects, the invention provides a cover for a golf club having a generally bulbous head area and an elongated sleeve area configured to fit over a golf club head and cover at least a portion of a shaft of the golf club. The cover includes an opening through which a shaft protrudes when the cover is on a golf club and at least one void through the cover. The cover can optionally include a second void, for example, disposed symmetrically to the first void and defining a handle therewith.

In some embodiments, the sleeve area or head area includes a stretchable material.

In certain embodiments, a sleeve of a cover of the invention includes an opening that further has a slash-style detail. A slash opening generally includes at least two flaps of material each with an edge, the edges generally parallel each other and capable of being brought together or pushed apart, somewhat like curtains joined at the top. A slash opening can optionally be structured like a placket. A slash opening can optionally include a fastening mechanism. Suitable fastening mechanisms include one or more of a button, zipper, Velcro, magnet, hook-and-eye, lace, and draw-string, solely or in any combination.

### BRIEF DESCRIPTION OF THE DRAWINGS

FIG. 1 is a perspective view of a golf club cover of certain embodiments of the invention.

FIG. 2 is a bottom view of a cover of certain embodiments of the invention.

FIG. 3 is a top view of a cover of certain embodiments of the invention.

FIG. 4 is a top view of a cover of certain embodiments of the invention.

FIG. 5 is a top view of a cover of certain embodiments of the invention.

FIG. 6 is a side view of a cover of certain embodiments of the invention.

FIG. 7 is a back view of a cover of certain embodiments of the invention.

FIG. 8 is a front view of a cover of certain embodiments of the invention.

FIG. 9 is a side view of a cover of certain embodiments of the invention.

FIG. 10 is a perspective view of a cover of certain embodiments of the invention.

FIG. 11 is a perspective view of a cover of certain embodiments of the invention.

FIG. 12 is a perspective view of a cover of certain embodiments of the invention.

FIG. 13 is a perspective view of a cover of certain embodiments of the invention.

FIG. 14 is a side view of a cover of certain embodiments of the invention.

FIG. 15 is a perspective view of a cover of certain embodiments of the invention.

FIG. 16 is a side view of a cover of certain embodiments of the invention.

FIG. 17 depicts a cover with a see-through panel.

FIG. 18 depicts a cover with a see-through panel and an opaque insert panel.

FIG. 19 shows a cover with a specific area marked for reference.

FIG. 20 shows a close-up detail view of a pattern of cells in a panel of material.

FIG. 21 shows a cover with a void, a see-through panel, and an opaque panel.

FIG. 22 shows a cover that has a bottle opener.

FIG. 23 shows a cover with a storage pocket.

FIG. 24 shows a cover with a pair of fasteners and an optional removable storage pouch accessory.

FIG. 25 is an illustration of a cover with an opaque panel insert according to certain embodiments of the invention.

FIG. 26 is an illustration of a cover with a see-through panel adjacent to a void to provide an expanded viewing area according to certain embodiments of the invention.

FIG. 27 shows a custom message strip for displaying a slogan.

FIG. 28 shows a message strip for displaying a customizable message.

FIG. 29 shows a display for receiving a consumer's selection of options.

FIG. 30 is a diagram of a method of providing a customized head cover according to certain embodiments of the invention.

FIG. 31 is a diagram of a system for providing a customized head cover according to certain embodiments of the invention.

### DETAILED DESCRIPTION

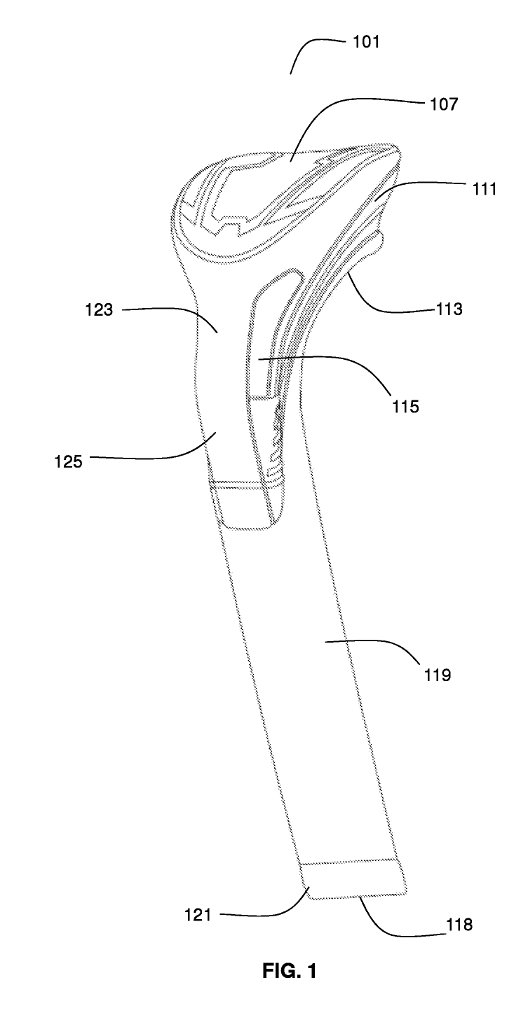

The invention generally provides a cover for a golf club. FIG. 1 shows golf club cover 101 of certain embodiments of the invention. Cover 101 can generally be described as having a crown 107, cheek 111, chin 113, nape 125, and a sleeve 119. Sleeve area generally terminates at a cuff area 121 defining opening 118 configured to receive a golf club head-first. Cover 101 includes at least one void 115 through the material. Cover 101 can include a second void 115.

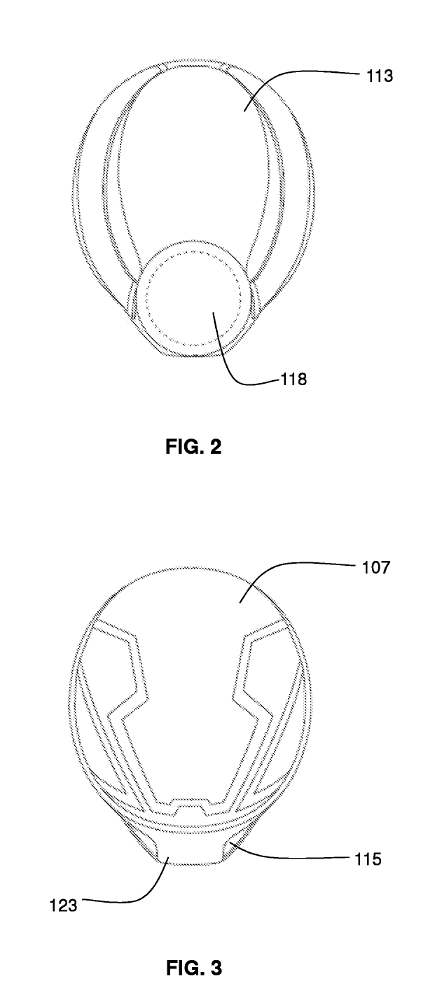

FIG. 2 shows a surface of chin 113 seen from beneath cover 101.

A crown 107 can include any manner of adornment, such as a pattern as shown in FIG. 3, or a logo, or other decoration. Crown 107, like any other area of cover 101, can include assembly seams where two edges of one or more panels of material are joined, or can include a single piece of material.

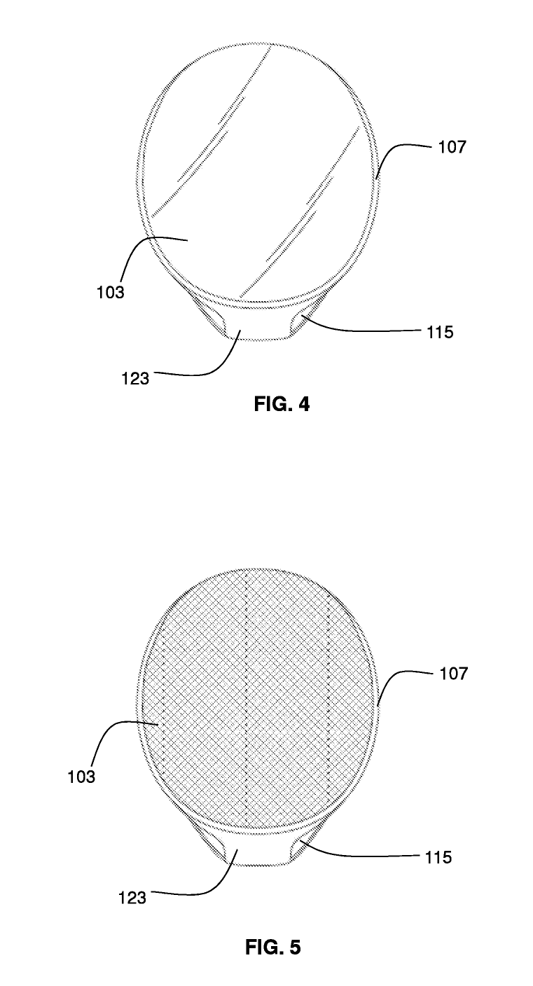

In certain embodiments, an area of the cover includes a window 103 for viewing something inside of the cover. For example, as shown in FIGS. 4 and 5, an outer perimeter of crown 107 can define window 103. Window 103 can include a see-through material. FIG. 4 shows window 103 including a transparent material such as a plastic as a see-through material. FIG. 5 shows window 103 including a mesh as a see-through material. Any material that can be looked through can provide see-through material, such as mesh or web, for example, as soccer-ball bags are made from.

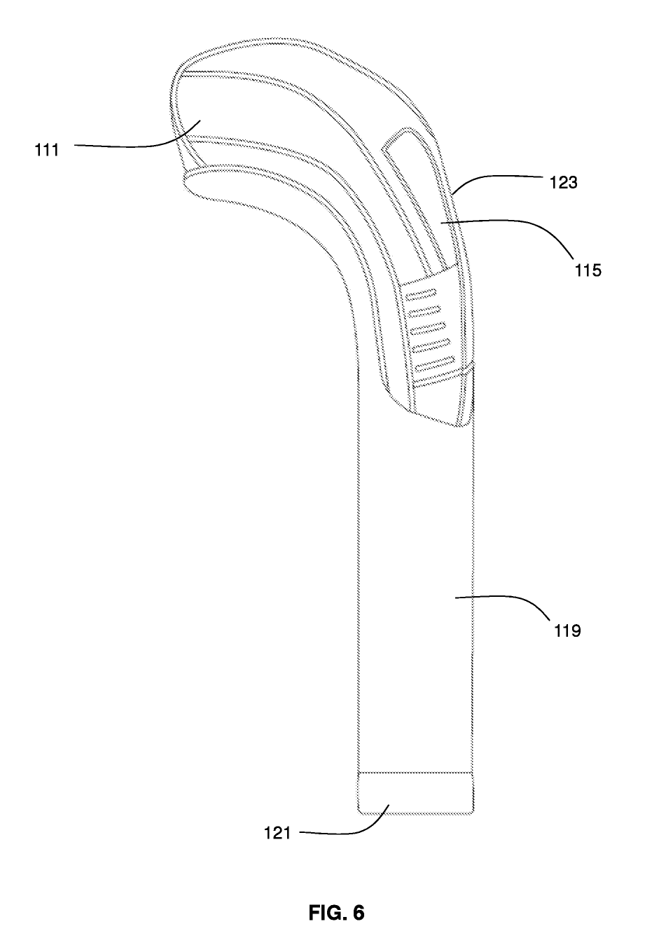

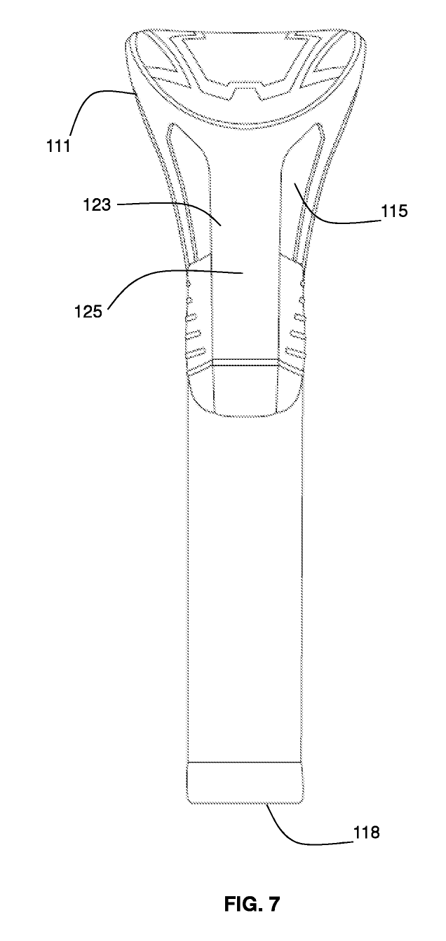

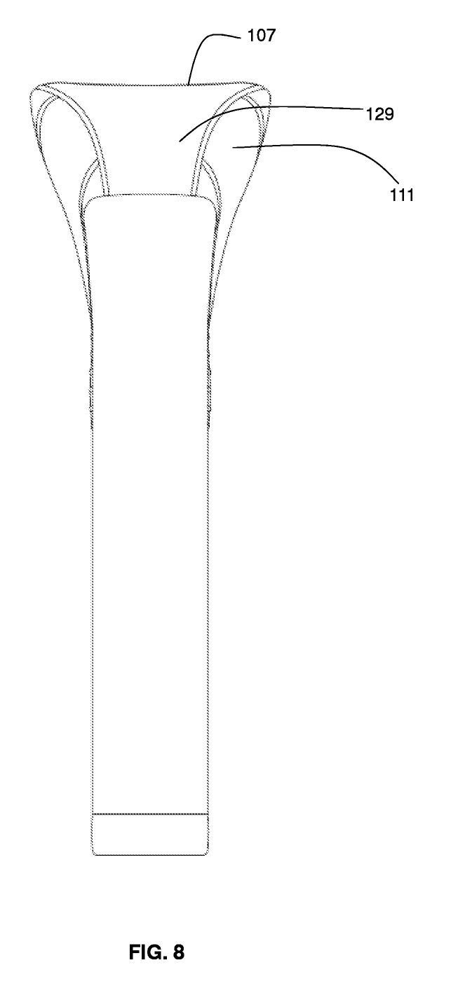

FIG. 6 is a side view of a cover of certain embodiments of the invention. In certain embodiments, void 115 can have a shape that is generally elongated including, either precisely or generally, a rectangular, oblong, or elliptical perimeter. An elongated void can have a length that is more than about 150% of its width, or optionally a length more than double a width. Cover 101 can include two of void 115 positioned to define bridge 123. In some embodiments, void 115 is generally positioned near a convergence of sleeve 119 and cheek 111. As shown in FIG. 7, in this disposition nape 125 generally supplies bridge 123. As shown in FIG. 8, void 115 does not have to be visible from all views. For example, viewing snout 129 reveals no voids. It is to be noted that no two figures in this application are limited to necessarily being illustrations of a single embodiment. Thus, FIG. 8 generally shows a front view of a cover of certain embodiments, and FIG. 7 generally shows a back view of a cover of certain embodiments, and some embodiments may be illustrated by both FIG. 7 and FIG. 8, in certain embodiments, a cover 101 may have features or aspects illustrated by one of FIG. 7 or FIG. 8 without conforming to the other figure, and so for all figures of the application.

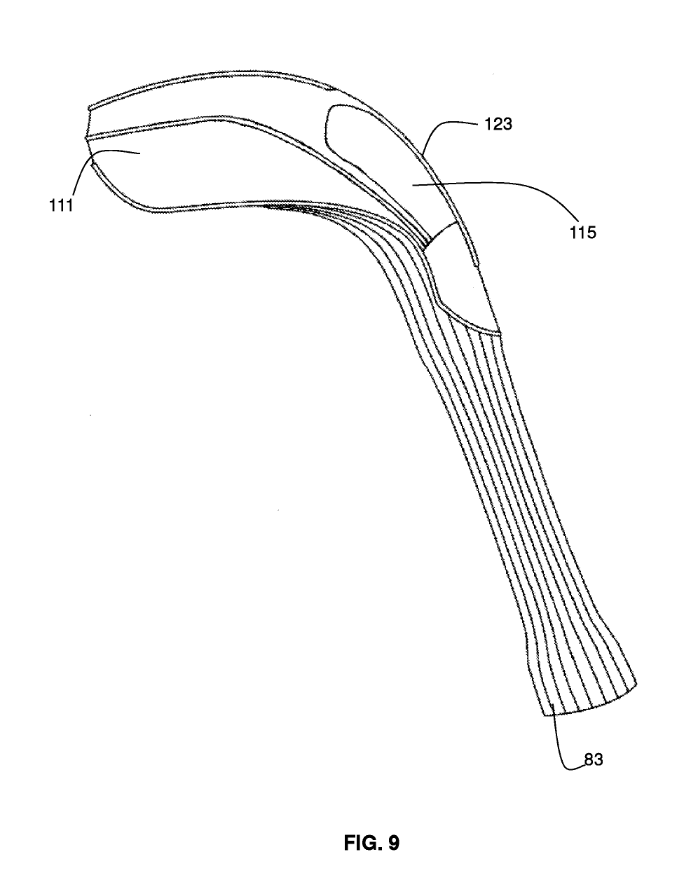

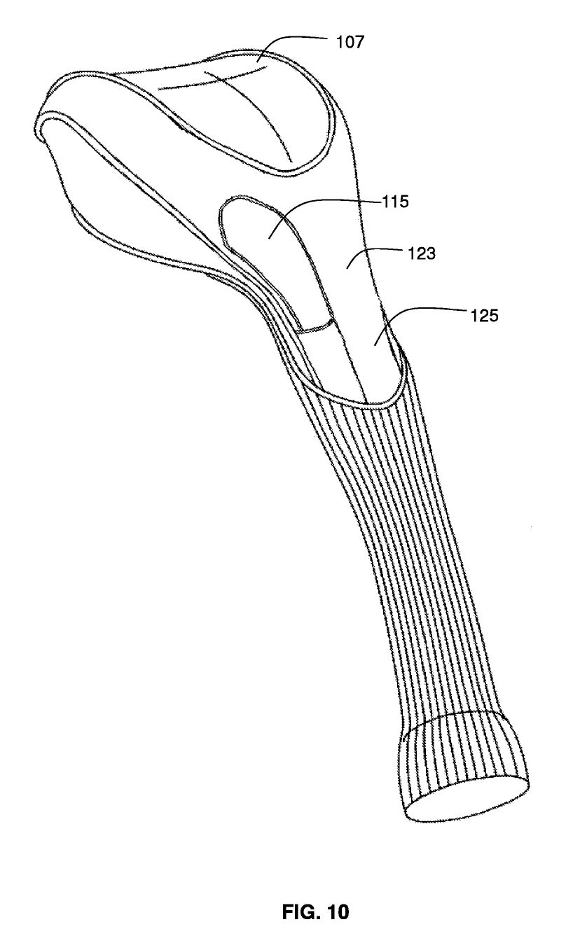

FIG. 9 shows a side view of cover 101 according to certain embodiments. Void 115 can be generally about 8 cm to about 10 cm long by about 2 cm to about 6 cm wide, while optionally being not strictly a rectangle or being a rectangle. In certain embodiments, void 115 can be large, about 15 cm to about 20 cm long by about 10 cm to about 15 cm wide. As shown in FIG. 10, two of void 15 can define bridge 123 spanning generally from the direction of sleeve area 119 in the direction of crown area 107 through nape area 125. For aesthetic or functional reasons bridge 123 can be tapered or curved or angled.

In certain aspects, the invention provides a cover for a golf club having a head area and a sleeve area configured to fit over a golf club head and cover at least a portion of a shaft of the golf club. The cover includes opening 118 through which a shaft protrudes when the cover is on a golf club and at least one void 115 through the cover. As can be seen with reference to FIG. 1 or FIG. 9, for example, in some embodiments cover 101 generally defines a surface from which no material protrudes. To provide a trim or pleasing appearance and to prevent annoying snags, cover 101—compared to a cover that has no void and is otherwise similar—according to certain embodiments of the invention has no additional material protruding from it or defining a feature. In some embodiments, one or more of void 115 and opening 118 present the only exposed material edge of cover 101. An exposed material edge generally refers to the exposed edge of a piece of material or the exposed edges of two pieces of material which are joined surface-to-surface over an area greater than a seam to form one generally flat piece of material (e.g., a shell and a lining). In some embodiments, every exposed material edge of cover 101 define a perimeter around either one or more of void 115, window 103, or opening 118 spatially connecting an interior space of cover 101 to an exterior space. As such, cover 101 need not present any loop or loop-like structure or strap-like piece of material fixed to cover 101, which does not also participate in defining one or more void 115 through the material of cover 101. Similarly, cover 101 need not present any material structure which defines a pocket and which does not also participate in defining one or more void 115 through the material of cover 101. Because the requirement of an external loop or pocket is avoided by void 115, additional material cost or manufacturing complexity is avoided. Further, a functional element is provided incorporated into the structure of cover 101 in a smooth and pleasing way. Thus it can be seen that cover 101 includes at least one void 115 defining a spatial opening between an interior volume of club 101 and the exterior space, such that at least one void 115 is independent of, or spaced away from, opening 118.

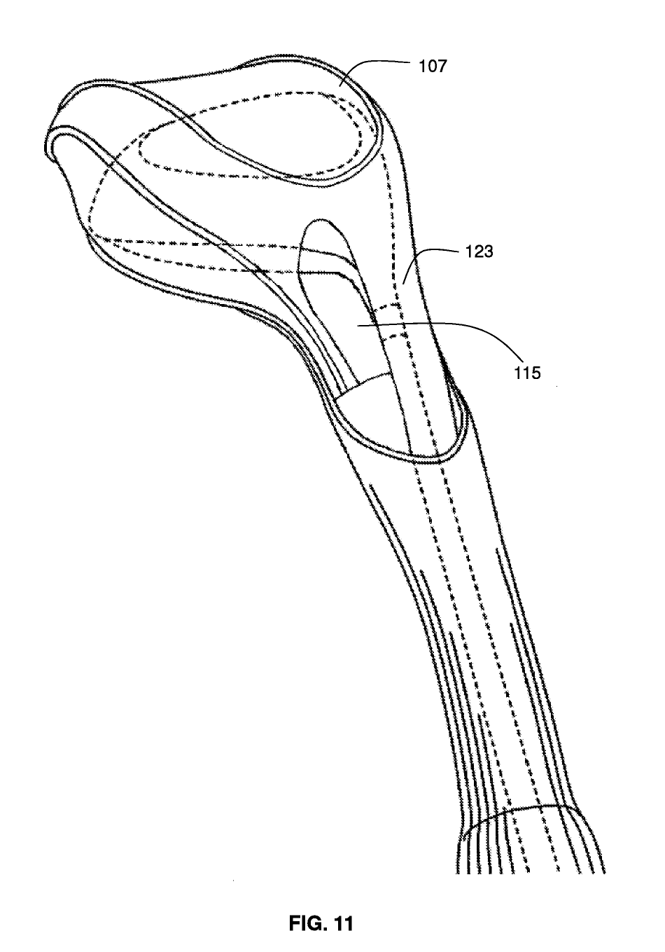

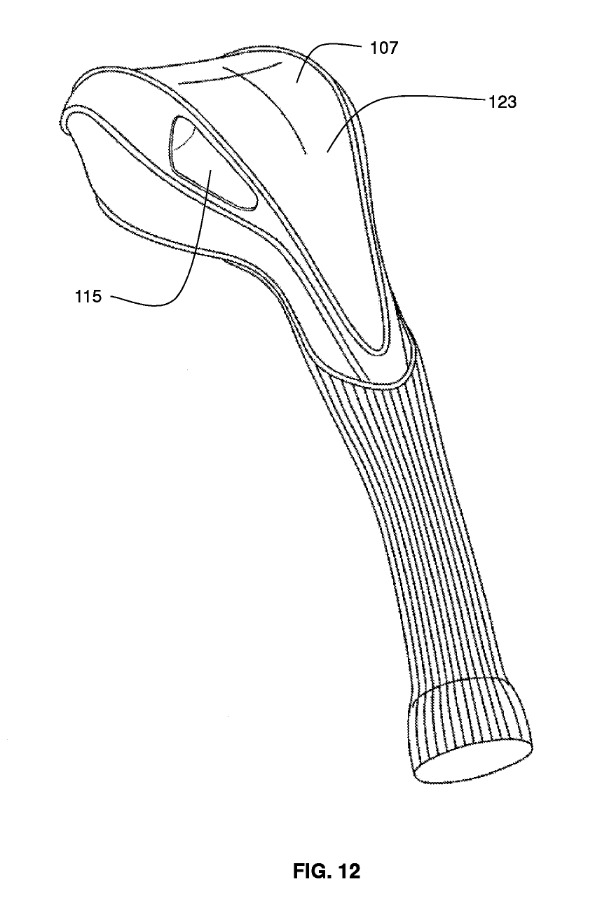

As shown in FIG. 11, cover 101 can cover a golf club. In certain embodiments, cover 101 is made large enough to enclose a driver with a head having a 460 cm³ volume. Cover 101 can also be made smaller, for example, to cover a hybrid or a wedge or a putter. In FIG. 11, a golf club is shown with a dotted line where a view of it is blocked by material of cover 101. Thus, crown area 107 is shown as including opaque material. In some embodiments (not shown in FIG. 11), crown area is window 103 including see-through material, and a golf club would be visible through window 103.

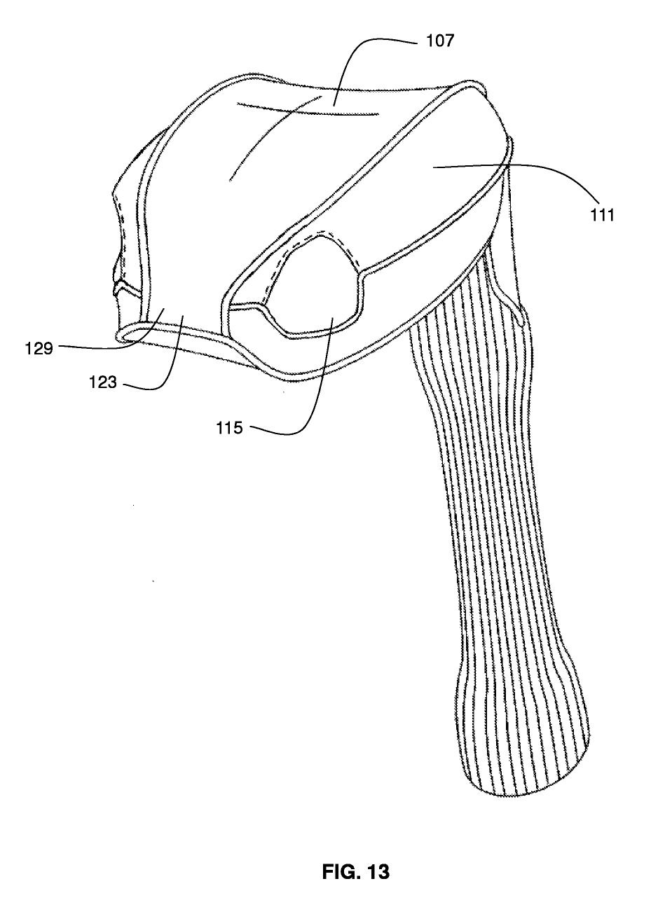

FIG. 12 is a perspective view of a cover of certain embodiments of the invention. As can be seen in FIG. 12, void 115 can be positioned anywhere on cover 101. As shown in FIG. 12, void 115 has a generally triangular shape with rounded corners. As shown in FIG. 12, void 115 is provided by a cutaway through a panel of material (e.g., void 115 does not abut an edge of a panel).

It can be seen that cover 101 can generally include panels of material joined at edges to define seams. In some embodiments, cover 101 includes one or more dummy seam areas—features fabricated to create the appearance of a seam (or piping) and overlaying a contiguous portion of a panel of material. A dummy seam may be included to create a visual continuation of a seam. A dummy seam may be included on a seamless club head for aesthetic purposes, for example, to create a vintage or hand-crafted appearance.

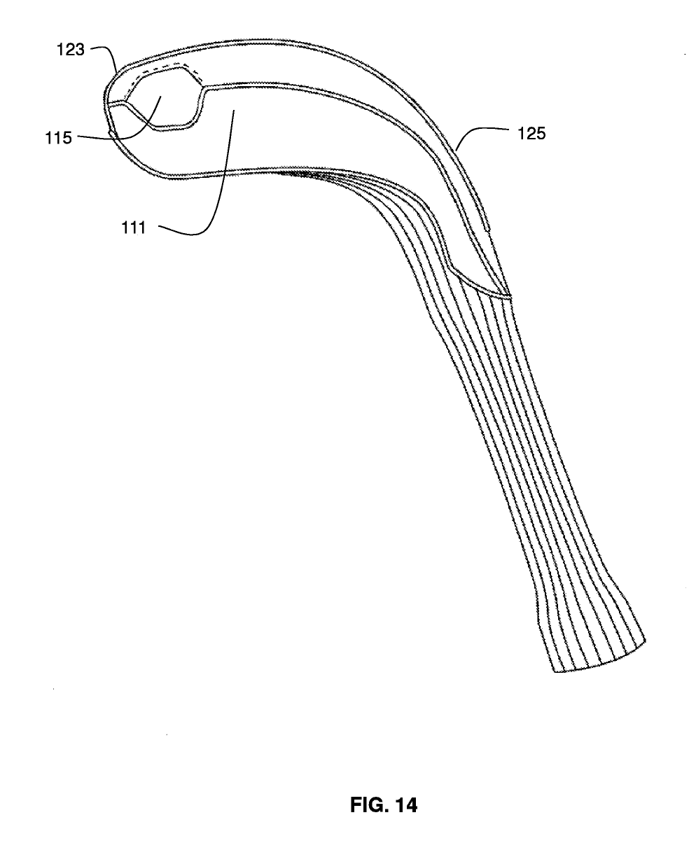

Turning now to FIG. 13, void 115 having a generally round morphology is shown. Void 115 can optionally be precisely round, hexagonal, or a hexagon with rounded corners or any other shape including regular or irregular polygons with rounded or true corners. As shown in FIG. 13, void 115 can be supplied by more than one cutaway into an edge of a panel of material, such that when two panels are joined at their two edges, two cutaways come together to define void 115. As shown in FIG. 13, an edge of a void or a seam can optionally be finished or adorned, for example, with visible stitching or piping. As shown in FIG. 13, a void can have a portion of an edge adorned with piping while also having a portion of an edge adorned with stitching.

In certain embodiments, function of void 115 is supplemented by an aesthetic appeal. For example, void 115 can be positioned to look like a grill or vent from an antique airplane or car. As shown in FIG. 13, two of void 115 can be provided disposed to cooperate with an overall shape of cover 101 to create a subtle suggestion of an animal head, for example, along with snout 129 and crown 107. As shown in FIG. 13, an area of material spanning crown 107 and snout 129 provides bridge 123, positioned to be gripped by a thumb and a pinky of a hand of an adult.

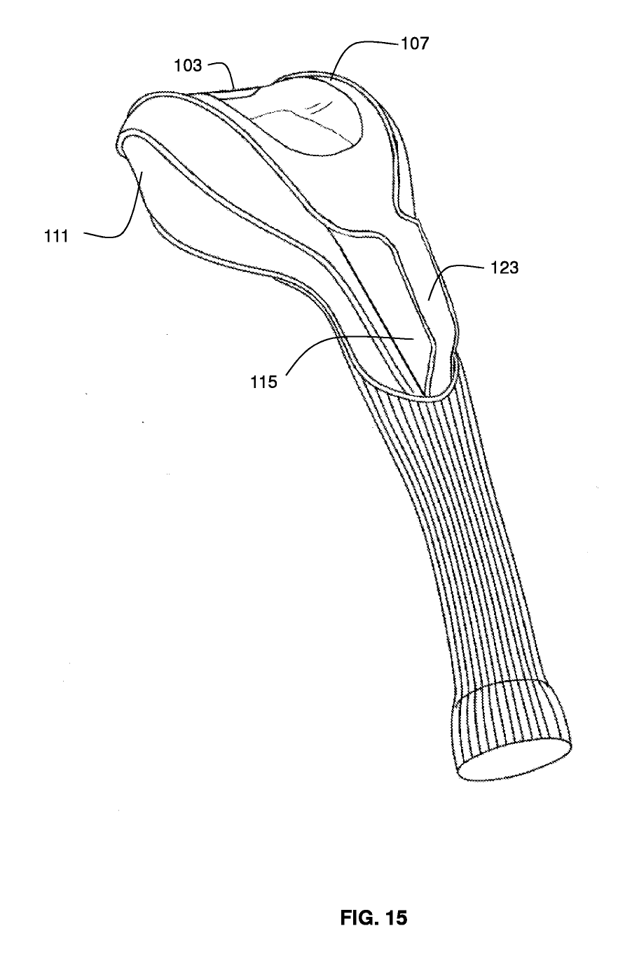

Two of void 115 can be disposed symmetrically on cover 101. As shown, for example, in FIG. 14, where no club is inside of cover 101, two of void 115 cooperate to provide a view through cover 101 to the far side. In certain embodiments, two of void 115 symmetrically disposed are positioned to augment their function as a pass-through for a tether, for example, to keep cover 101 with a club bag for example, in the back seat of a convertible out on a highway. In certain embodiments, cover 101 includes a tether. A tether, generally, is a string-like or strap-like portion of material either provided along with, fastened to, or integrally formed with cover 101. A tether can include an extension of material, for example, material of a panel of cover 101. A tether can include a cord or string-like member, for example of wire, nylon, wool, leather, hemp, or other material. It can be advantageous to provide a tether with cover 101, for if cover 101 is designed for optimum performance or consumer appeal, a golfer would not want to drop or loose the cover from a golf bag or golf cart. Further, by supplying tether with cover 101 it can be ensured that cover 101 and the tether match or complement one another, in color or material choice, for example. In some embodiments, a tether has a hook or fastening mechanism at either or both ends or is designed to pass through void 115.

FIG. 15 illustrates an exemplary window 103 according to certain embodiments of the invention. As shown in FIG. 15, crown area 107 includes window 103 set therein. Window 103 is formed of a clear flexible material such as a transparent plastic. It will be appreciated that window 103 as shown in FIG. 15 can be provided with any combination of any one or more void 115, bridge 123, or any combination thereof. Window 103 can have any shape, size, or position on cover 101, and can include any see-through material.

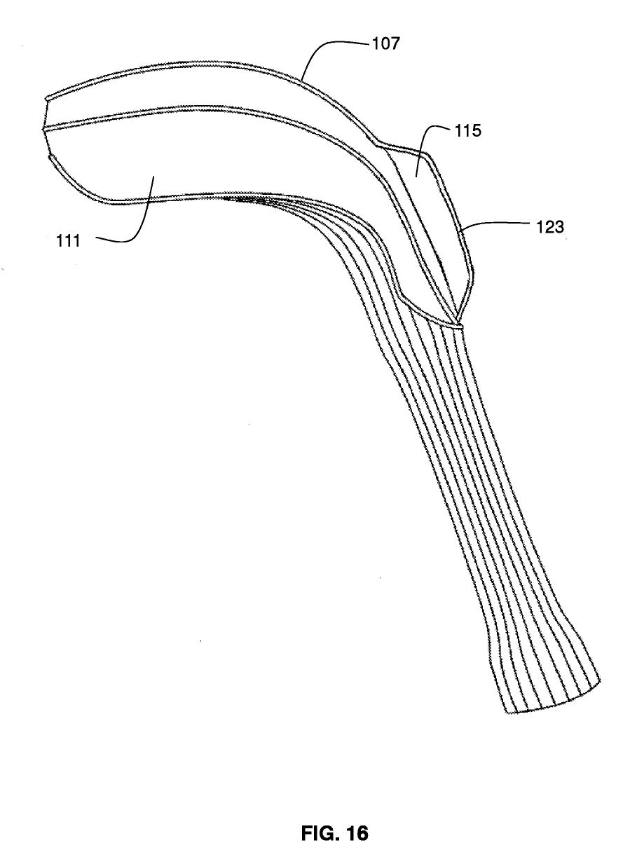

In certain embodiments, void 115 is disposed to augment a handle-like appearance of bridge 123. This can, for example, provide the subtle visual suggestion to a golfer to use void 115 has a handle for taking cover 101 off of a club, as shown, for example, in FIG. 16.

In general, for all examples or embodiments, cover 101 may protect a golf club, for example a wood type club, or a club of virtually any configuration may be encompassed by the features of the present invention, for example hybrids, putters or irons. Generally, regardless of club type, a golf club will generally have a head, and a shaft. The shaft may be generally attached to the head by means of a hosel. Further, the club head can be described as having a heel, a toe, a crown, a face, and a sole as well as optionally a skirt generally separating the crown and sole along a rear periphery of the head. Optionally, the club may further incorporate a ferrule.

Regardless of club type, the cover 101 may surround the club head and a predetermined length of the shaft. Cover 101 may also surround the hosel or the ferrule, if provided. It is common for certain golf club types, e.g. woods and putters, to utilize hosel-less construction, thus it should be appreciated that, as with the ferrule, the hosel feature need not necessarily be present on the club.

It may be appreciated that cover 101 is described in certain embodiments as having a fitted shape by way of example only, where the head area may be shaped to correspond to that of the head of the golf club. More specifically, the head area may include a variety of panels shaped to substantially surround the club head. Such features may include at least one upper panel substantially provided to cover the sole (see, e.g., FIG. 11) of the wood type club, at least one lower panel substantially provided to cover the crown, and cheek panels joining the upper and lower panels. The shape of the panels will be dependent upon the shape of the club for which they are constructed, design objectives, fabrication constraints, or other factors, but in any event may form a cover to surround the club head.

Cover 101 can include a variety of design features in various combinations. For example, in FIG. 12, crown 107 is shown to include an inverted arcuate surface contour. In certain embodiments, cover 101 is further provided with an accessory, such as a pocket or enclosure, for example, to hold keys or an electronic device. Cover 101 could include a solar panel or a mechanism for fastening an accessory such as a solar panel, for instance, to provide a charge to an electronic accessory or to charge a battery. Cover 101 can include a pocket with a clear panel, or window 103 can be provided to reveal an enclosure, such that, for example, an identification card or a screen of an electronic device can be presented therein.

Void 115 according to the invention can be supplied by a an opening through a surface at which a flap of material remains. While voids, generally, are described as openings through a surface having a perimeter exposing an edge of material, in certain embodiments, a void is formed by cutting less than entire perimeter into material (e.g., two or three “sides” of a shape), leaving a flap, or providing a full void and adding a flap to create a similar affect. In some embodiments, a void has an openable and closeable mechanism, such as a shutter, Velcro flap, sliding panel, or other mechanism. Void 115 generally includes any feature capable of providing a spatial connection between an interior volume of cover 101 and an exterior volume.

Further as shown, for example, in FIG. 12, cover 101 can include an upper panel that may taper to a reduced tail end over any or all of a hosel-area. By this shaping of the upper panel, the shape of cover 101 may follow the form of the club itself, and may inherently lend protection to the sole and hosel of a club. Similarly, the shape of a lower panel may be defined by the shape and size of a crown, for example, by being substantially disc shaped or oblong disc shaped as is shown for chin area 113 in FIG. 2. Again, the inherent configuration of chin 113 lends protection to the crown of a club head. While cheek 111 may include a side panel having any of a number of shapes, a side panel may be generally laterally oriented with respect to the upper and lower panels and may provide height or dimension to cover 101 and may aid in shaping cover 101.

Sleeve 119 may include an opening 118 through which the club passes. Sleeve 119 may include an expansible material to facilitate sliding of cover 101 over a maximum girth of a club head. Further, as may be seen in FIG. 9, the expansible material may partially extend into chin 113, cooperating with void 115 to define an expansible region. Sleeve 119 may, for example, include a generally cylindrical tube including expansible material. Accordingly, the throat area of cover 101 may expand at a location where the club head slides through this relatively narrow portion, yet may still include a relatively more rigid or less resilient material for its construction. Alternatively, the throat area may be provided with more than one expansible region 15 (not shown) made from, for example, a material that is more resilient than the material used to form other parts of the club head, thus achieving the same goal. In some embodiments all or part of a throat area, all or part of sleeve 119, or both are provided by a material in a gusset form, including accordion folds. In certain embodiments, a void 115 is provided filled with a expandable or compressible gusset including, for example, fabric, TYVEK, or other material. In certain embodiments, a gusset is provided as a panel of cover 101, generally near the throat area. A gusset, generally, includes a zigzag, or accordion, folding area and defines a first area at rest, and can be expanded to define a larger area or compressed to define a smaller area.

These constructions may, for example, enable the insertion of even jumbo club heads into cover 101 while maintaining a streamlined and appealing appearance that protects the club head. The materials used to form the head region of cover 101 may thus be chosen over any range of stiffness, resiliency, and/or elasticity that, for example, provides sufficient protection to the club housed therein, and remains easy to slide on and off of the club during use while providing any desired shape or cosmetic appearance.

Further, should cover 101 incorporate panel construction, bridge 123 may be, for example, substantially completely formed using the material of an individual panel, as shown in FIG. 1. Further still, bridge 123 may be, for example, partially formed using the material of an individual panel. Bridge 123 may be formed, for example, from a separate piece of material appended to or attached to one or more panels. In some embodiments, one end of bridge 123 is appended to or attached to one or more other panels, for example, as shown in FIG. 10. Thus, the overlap may be sewn or otherwise fixed. If panel construction is used, exemplary materials for panels may include fabric, reinforced fabric, elasticized fabric, leather, neoprene, vinyl, and/or any other appropriate material.

It will be appreciated that one or more of void 115 or bridge 123 may be advantageously positioned to provide substantially maximum pull or leverage with substantially minimal effort. In other words, the location of one or more of void 115 or bridge 123 may be such that the frictional resistance between cover 101 and the club head may be overcome with a reduced amount of effort when removing cover 101 from the golf club, compared to an amount of effort required to remove a conventional head cover.

In certain embodiments, one or more of void 115 allow a portion of a golf club to protrude out of a predominant volume of cover 101. For example, in some embodiments, one or more of void 115 are positioned so that a heel sole corner of a face, a heel sole region of a back of a club head, or both protrude out through the one or more of void 115 at some stage during the covering or uncovering of a golf club with cover 101. For example, in some embodiments, a driver type club will have a large head, and while cover 101 is being pulled over the head, a portion of the head will pass through the voids temporarily, thereby avoiding a stress or resistance that would be encountered in a void-less cover.

In certain embodiments, one or more of void 115 is designed so that a portion of a golf club protrudes through the void while the club is covered by cover 101. For example, a designer may provide a club and cover 101 wherein the club has a protruding-out portion, such as a curved corner-area of a head, and cover 101 has void 115 in a corresponding place such that when the head is covered, the protruding-out portion projects outward through void 115.

Void 115 can be designed, for example, with a design of a golf club in mind, to reveal a portion of a golf club such as mark. A mark can include a graphic or a logo, such as a corporate trademark or functional indicia, such as a scale or other indicia associated with a setting in an adjustable club head. In some embodiments, a logo or graphic is printed on a portion of the club head, such that it appears through void 115.

In certain embodiments, for example, as shown in FIGS. 1 and 15, bridge 123 occupies nape area 125 and provides functionality as a handle. Due to the exemplary provision of an expansible throat area as provided by sleeve 119, void 115, choice of materials, a gusset, or any combination thereof, this location for bridge 123 may render removal of cover 101 from the club more efficient, that is, for example, requiring a lesser amount of effort from the end-user compared to an amount of effort required to remove a conventional head cover.

Additionally, any panel of material or portion of cover 101 may be tactually distinguishable from a remainder of cover 101. For example, bridge 123 may be texturized, rubberized, and/or otherwise made to have increased tackiness to provide a good hand-grip. In certain embodiments, an inside of bridge 123 has a grip member mounted thereto, the grip member optionally including divots, ridges, or other elements. In some embodiments, a grip member includes a protruding ridge-like element with one or more crescent hollows. A crescent hollow can have a radius substantially similar to the cross section of a finger of a human hand. By presenting a ridge having a row of crescent hollows, for example, four crescent hollows, the grip member can offer a useful handgrip, a visual communication to a user that bridge 123 is intended as a handgrip, or both. It will be appreciated—for the purposes of illustration and analogy and without limit—that a grip member with a series of four crescent hollows may generally present an appearance similar to a part of a handgrip on the handlebars of a bicycle. A grip member of the invention can comprise rubber, plastic, leather, neoprene, any other material known in the art, or a combination thereof.

All elements shown and described in connection with the examples herein are intended to be interchangeable. A gusset, window 103, void 115, bridge 123, a panel of material, grip member, and slash opening may be used in any number and in any combination with each other.

Further, it will be appreciated that the connection of club head cover components, if so required, may vary to include, for example, stitching, riveting, welding, stapling, adhesive bonding, hook and loop type fasteners, and/or any other suitable joining technology.

Typical materials for cover 101 may include, for example, molded polymers, plastics, neoprene, mesh, leather, vinyl, fabric, reinforced fabric, or any combination thereof. Optionally, a knit or ribbed elastic material may be used for the sleeve portion such as from neoprene, elasticized fabric, a ribbed and elasticized fabric, and/or similar expansible material. In some embodiments, a cover according to the invention is made with recycled material, thereby increasing an appeal to the environmentally minded consumer while also offering the manufacturer a sustainable product to make and sell, allowing the manufacturer to provide products for longer into the future. Material for a cover can be renewable or organic, such as hemp fiber. Hemp fiber and similar materials are durable, light, and popular, offering a cover that is light and durable with sales appeal. Covers according to the invention can further be made with material that decomposes readily or harmlessly, such as photodegradable or biodegradable materials. In some embodiments, cover 101 includes a photodegradable material, for example, on the inside surface, or as a rigid panel insert into a thin (e.g., nylon, cotton, polyester, leather, etc.) outer fabric part. An exemplary photodegradable material for incorporation into cover 101 is low-density polyethylene, although any photodegradable material may be used, for example, as described in U.S. Pat. No. 4,042,765, incorporated by reference herein in its entirety. In certain embodiments, cover 101 includes biodegradable material, including, for example, cotton, hemp, cellophane, biodegradable plastic, polyhydroxybutyrate, polyvinyl alcohol, polyglycolide, polycaprolactone, polylactic acid, or similar. In some embodiments, cover 101 includes a bioplastic or organic plastic such as a plastic derived from renewable biomass sources, such as vegetable oil, corn starch, pea starch, or microbiota, rather than fossil-fuel plastics which are derived from petroleum. Window 103 can optionally include cellophane. Materials used may, for example, provide protection to the club head and hosel while enabling secure engagement of the club cover with the club head, hosel and a portion of the shaft. In some embodiments, a corrugated material is used to increase resiliency or decrease material. Exemplary corrugated materials include cardboards, fiberboards, plastics (e.g., coroplast or any of the corrugated plastic sheeting sold under the trademarks INTEPRO, CORREX, or TWINPLAST), and stiff fabrics and can include any of A-Flute through F-Flute construction. In some embodiments, a plastic material is included having an SPI resin identification code of 5 or lower, or 4 or lower. In some embodiments, polylactic acid (e.g., made from corn starch or cane sugar) is used in making cover 101. Since void 115 decreases a total amount of material consumed in making cover 101, further including recycled, recyclable, compostable, degradable, or other environmentally-friendly materials naturally complements the decreased consumption of resources, providing cover 101 with an optimized consumer appeal.

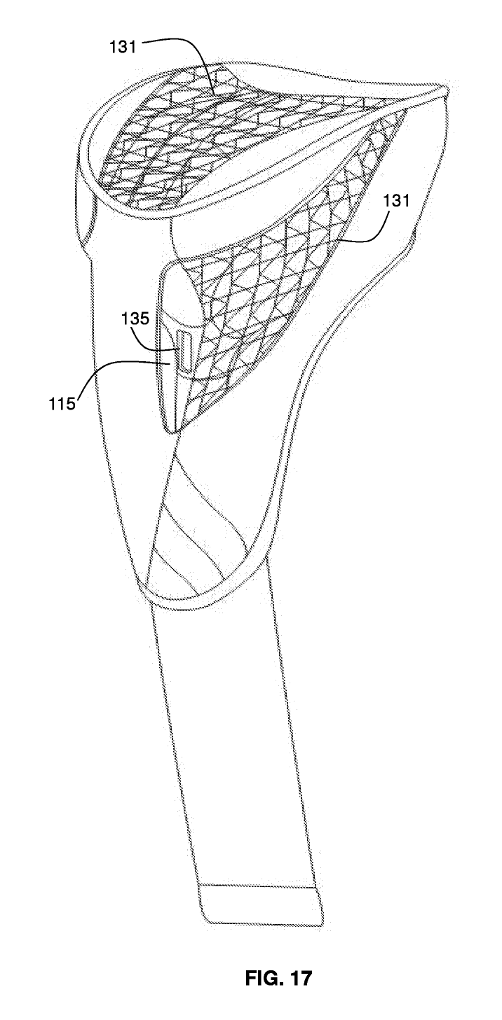

In certain embodiments, the invention provides a cover for covering a golf club through which at least a portion of the club can be seen via a void, a see-through panel, or both. FIG. 17 depicts a cover with a see-through panel 131. As shown in FIG. 17, one or more of see through panel 131 can allow a user to see a golf club 135. Here, one of panel 131 abuts void 115, thereby creating a large area through which a club can be seen.

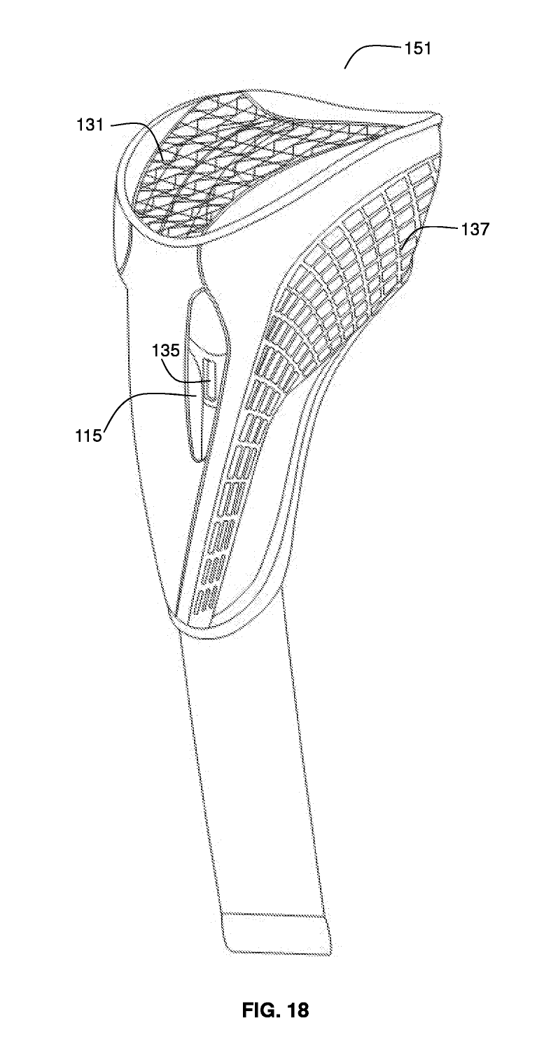

A see-through panel can be provided by any suitable material such as those described herein and, further, such materials can also provide an opaque insert panel. FIG. 18 depicts a cover with a see-through panel 131 and an opaque insert panel 137. A variety of benefits can be obtained by including one or more of a see-through panel and an opaque insert panel. Such panels can be used to increase the rigidity of the cover, thereby offering greater protection to the club. Such panels can be provided by environmentally friendly materials. Such panels can match each other, creating an attractive finish giving a cover greater consumer appeal. Further, panels can have textures or patterns which can decrease weight or optimize plastic/elastic properties.

A see through panel or an opaque panel can be provided by any suitable material known in the art including any of those described herein. Suitable materials include rigid and flexible vinyl, polyurethane foam, ABS, acetate, polyethylene, polypropylene, color coded shim stock, Mylar, Kapton, Teflon, and Nylon such as are available, for example, from Die-Cut Products Co. (Cleveland, Ohio). Other suitable materials include flexible or rigid plastic films that can be clear, colored, or translucent. Such films can include UHMW polyethylene film or PTFE film such as are available in thicknesses ranging from 2 mil. to 60 mil. from Fluoro-Plastics, Inc. (Philadelphia, Pa.). Such materials can offer tensile strengths less than 1,500 psi, elongation up to 200 percent & dielectric strengths of 500 V/mil. Suitable materials further include flexible plastic films made from LDPE & MDPE polyethylene resins such as are available from Brentwood Plastics, Inc. (Saint Louis, Mo.). Plastic materials of polyester, vinyl, acetate, polyethylene, or polypropylene types can provide flexible or porous panel inserts that can be seamed and bonded, such as those materials available from Grafix Plastics, a division of Graphic Art Systems, Inc. (Cleveland, Ohio). Insert panels can be made fire retardant, anti-static, low-skid, or embossed, and can be welded, for example, using RF, heat, or ultrasonic energy. Insert panels can be cut from sheets that are obtained pre-embossed with a pattern such as taffeta, box taffeta, diamond, matte finish, micro matte, frosted, dimpled, linen, leather grain, diamond plate, polished, or woven textured. Such materials can be obtained, for example, from Bloomer Plastics, Inc. (Bloomer, Wis.).

In certain embodiments, a cover includes a rubber material. For example, an insert panel can include rubber to create resilience or a desired aesthetic effect. Suitable rubber materials and related materials include, without limit, natural rubber, EPDM, EPT, EPR, SBR, neoprene, nitrile, millable gum, epichlorohydrin, Silicone, polyacrylate, flourisilicone, butyl rubber, and flourelastom, which materials are available from firms such as Bloomer Plastics, Inc.

In certain embodiments, one or more of see-through panel 131 or opaque insert panel 137 includes a polyvinyl chloride (PVC) material, for example, cut from a sheet. PVC, PVC-alloy, and CPVC film and sheet products in fire rated, ultra high impact, corrosion resistant, and economy grades can be obtained smooth or with textures and in a wide variety of solid and integral colors (e.g., metallic) and can be thermoformed or machined. A variety of such PVC materials are sold under the trademark BOLTARON by Boltaron (Newcomerstown, Ohio). Such materials include the monolithic Type 1 PVC sheet sold under the trademark BOLTARON 1050, which is free of pits, voids and inclusions, and not subject to delamination. A high heat distortion, fire retardant, extruded thermoplastic sheet designed to meet stringent FAA flammability requirements and higher in-service temperature applications can be provided by the PVC sold under the mark BOLTARON 4205.

See-through panel 131 can be provided by a highly transparent material such as the nylon material sold under the trademark NYLON CAST or NYLON BIAX from Transilwrap Company, Inc. (Franklin Park, Ill.). These materials offer high transparency, excellent durability and good gas, grease and moisture barrier properties as well as puncture and crack resistance. In certain embodiments, one or more of see-through panel 131 or opaque insert panel 137 includes polytetrafluoroethylene such as that sold under the trademark TEFLON and made by E.I. Du Pont De Nemours and Company (Wilmington, Del.).

A club head cover of the invention can further include an environmentally friendly material that allows a firm to produce a product more sustainably and also promote consumer acceptance.

Any portion of cover 151 can include, for example, a recycled plastic such as the high quality ecological microfiber Dinamica from MIKO S.r.l. (Gorizia, Italy). Dinamica is made via a water-based manufacturing recycling process with minimal environmental impact. The faux suede material is produced from a combination of recycled polyester and polyurethane fibers, and is also 100 percent recyclable. The fabric also has an anti-slip grip quality and can therefore be used for a cover that will not fall off or that a golfer can get a good grip on when they wish to remove it.

Dinamica is extremely strong at critical points, such as edges and seams, and it also demonstrates remarkable lightfastness. It is highly wear-resistant and the microfibers are totally pilling-free (so even after extensive use, unsightly small bobbles don't build up on the fabric). The microfiber provides softness, elasticity and breathability, and because it is waterproof, it also proves resistant to stains. Dinamica is made via non-toxic production methods under Oeko Tex Standard 100 certification. Dinamica is available in a full spectrum of colors including light and pastel shades with sunlight-resistant dyes that do not fade over time. In certain embodiments, one or more Dinamica portions include a design made, for example, by laser, embossing, or perforation, such as a corporate logo, decorative element, or cells (e.g., a cell pattern).

In certain embodiments, a portion of cover 151 includes an environmentally friendly plastic such as one made from agricultural or marine feedstocks or a biodegradable plastic. Such materials include the biaxially oriented film biopolymer 4043D or 4032D film sold under the trademark Ingeo by Natureworks LLC (Minnetonka, Minn.), which can be extruded, made of polylactic acid, or compostable. In certain embodiments, a plastic insert panel includes biopolymer 7001D injection stretch blow molded plastic sold under the trademark INGEO by Natureworks LLC. Other exemplary materials include flexible PVC extrusion compounds sold under the trademark APEX by Teknor Apex Company (Pawtucket, R.I.) or flexible PVC sold under the trademark BIOVINYL from Teknor Apex Company (Pawtucket, R.I.). Flexible PVC sold under the trademark BIOVINYL includes a bio-based plasticizer sold under the trademark DOW ECOLIBRIUM. This provides a rapidly renewable alternative that is phthalate free and offers a sustainable option with a carbon footprint that rivals all polyolefins, polyurethane and most commercial biopolymers. Flexible PVC sold under the trademark BIOVINYL provides all the benefits of traditional vinyl such as processability, UV resistance and durability as well as improved heat stability, plasticizer efficiency, abrasion resistance and tensile strength.

In certain embodiments, a plastic material in cover 151 includes an additive to encourage the plastic to degrade such as the additive sold under the trademark ECOPURE by Bio-Tec Environmental LLC (Albuquerque, New Mex.). When such a biodegradable plastics additive is mixed into raw plastic (e.g., at less than 1%), it allows that plastic to break down when placed in a microbe rich environment, such as a landfill or compost facility.

By using materials such as those exemplified by the discussions herein, a cover can be provided that is lightweight, strong, environmentally friendly, and attractive.

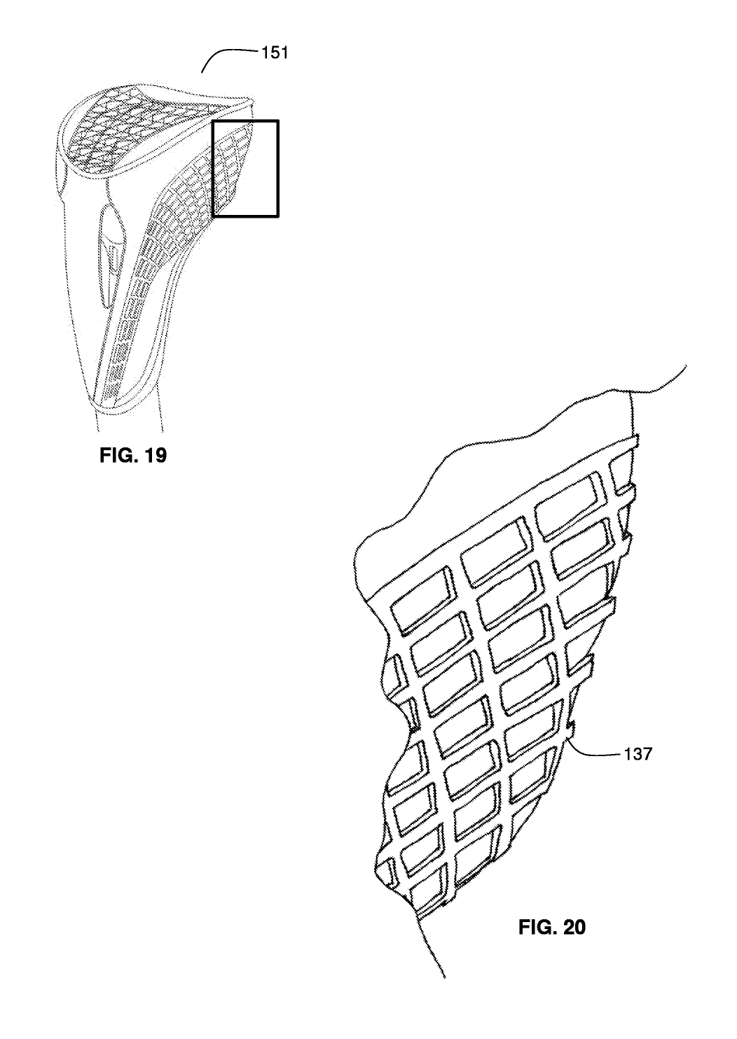

Further, a portion of the material of cover 151 can include a cell structure to decrease weight while maintaining strength. FIG. 19 shows a cover with a specific area marked for reference. FIG. 20 shows a close-up detail view of a pattern of cells in a panel of material. As can be seen in FIG. 20, a cell structure can refer to a pattern of hollowed-out areas that decrease a volume of material in the hollows, while leaving a surrounding mesh-like framework giving the material an overall thickness, or an effective thickness, of the thickness of the mesh-like structure.

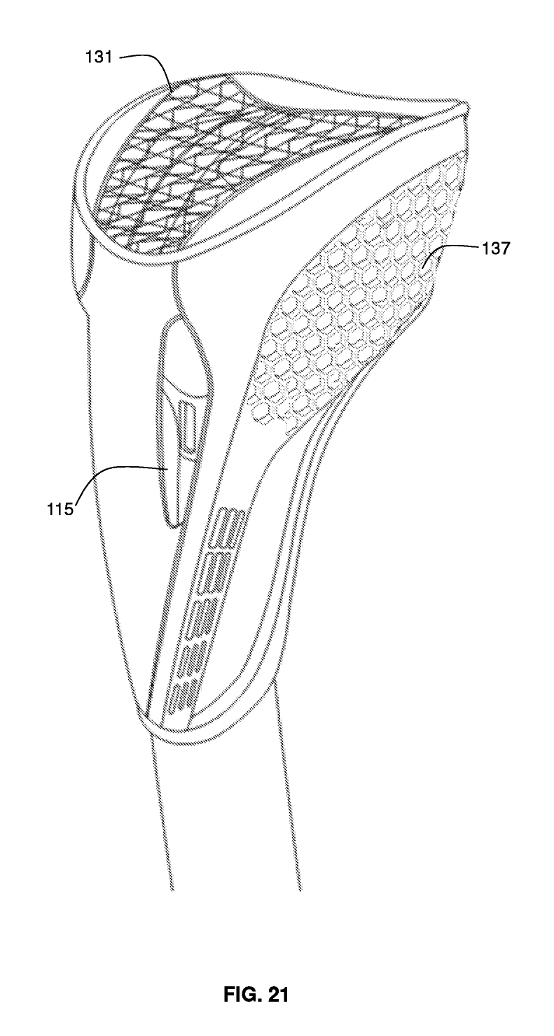

In certain embodiments, the invention provides a cover with any one of the features disclosed herein (e.g., a cover with a void, a cover with a see-through panel, a cover with a functional accessory, or a cover with an opaque insert panel). In some embodiments, the invention provides a cover with a combination of features that operate together to make a strong, light cover that allows a golfer to view a covered club while offering good protection. FIG. 21 shows a cover with a void 115, a see-through panel 131, and an opaque panel 137. As shown in FIG. 21, panel 137 has a honeycomb-like cellular structure comprising a series of hexagonal hollows in the surface of panel 137. Note further that see-through panel 131 has a mesh-like textured surface while being a substantially transparent plastic, such as a PVC film as discussed above.

In certain embodiments, a cover further includes a functional accessory. A golf club cover is disclosed here to be a good place to mount a functional accessory because the cover is typically near a golfer while on the course, but not encumbering a golfer while he or she actually makes a shot. Since the golfer leaves the cover with the golf bag while they tee up, the cover is a good place to include a heavy item or a novelty item.

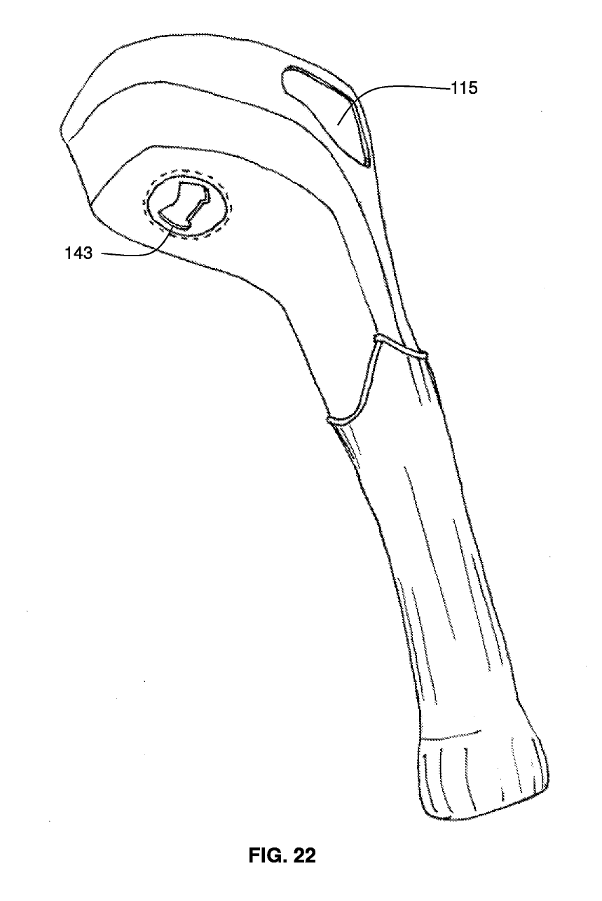

FIG. 22 shows a cover that has a bottle opener 143. Bottle opener 143 can be positioned anywhere on a cover, such as attached to a lanyard that is attached to sleeve area 119. As shown in FIG. 22, bottle opener 143 is mounted within the chin area of a cover. This way, when the cover is on a club in a golf bag, bottle opener 143 is positioned in the proper orientation to open a bottle while keeping the bottle right-side up.

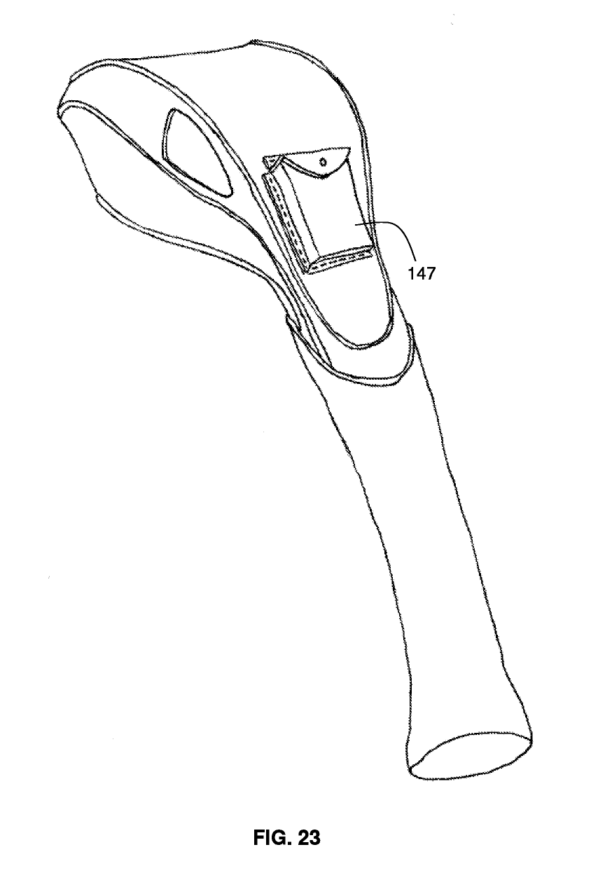

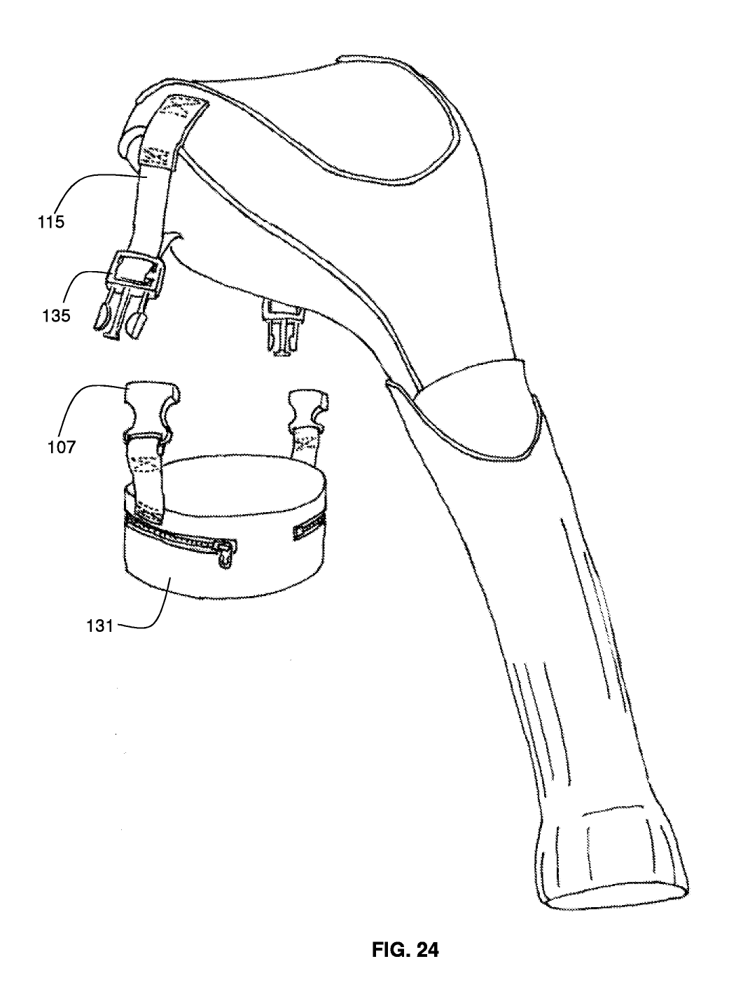

A cover can further include a storage pocket 147, such as is shown in FIG. 23. Storage pocket 147 can be provided in a generally useful size, or it can be provided in a size and shape that is customized to hold a specific item such as tees, a smartphone, or a notepad. As more golfers carry and use smartphones while playing golf, a cover is an opportune place to locate a pocket for a smartphone.

In certain embodiments, a cover includes a removable accessory such as the removable pouch shown in FIG. 24. By providing one or more of fastener 135 on strap 115, any suitable accessory can be removably mounted to the cover. As shown in FIG. 24, zippered pouch 131 with coupling binder 107 can be attached to the cover. It will be appreciated that a fastening mechanism such as fastener 115 thus provides a very useful general-purpose removable accessory coupler. In some embodiments, strap 115 includes Velcro, snaps, or other fastening means.

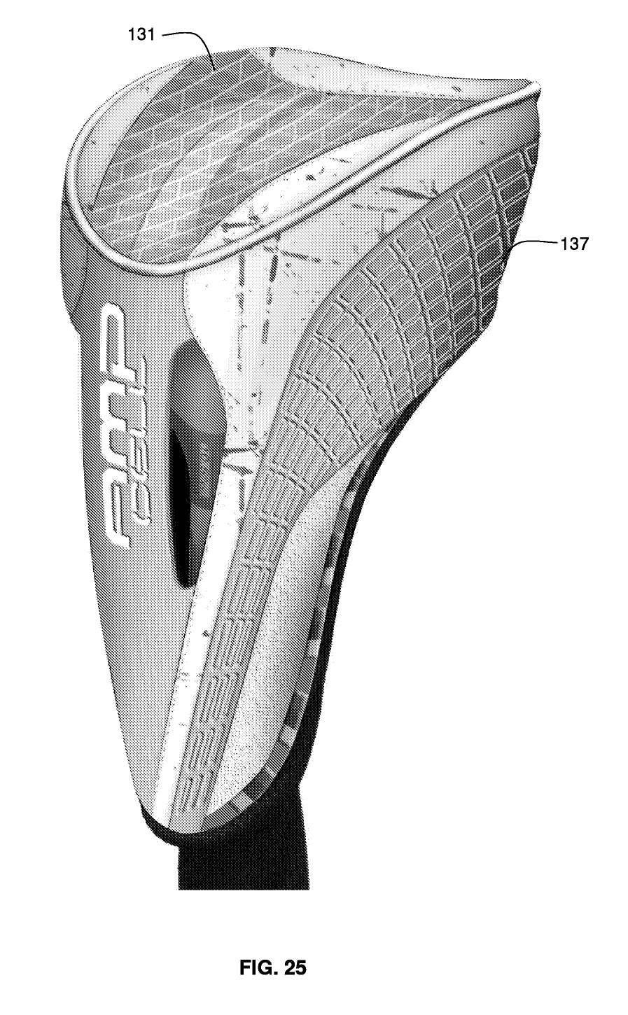

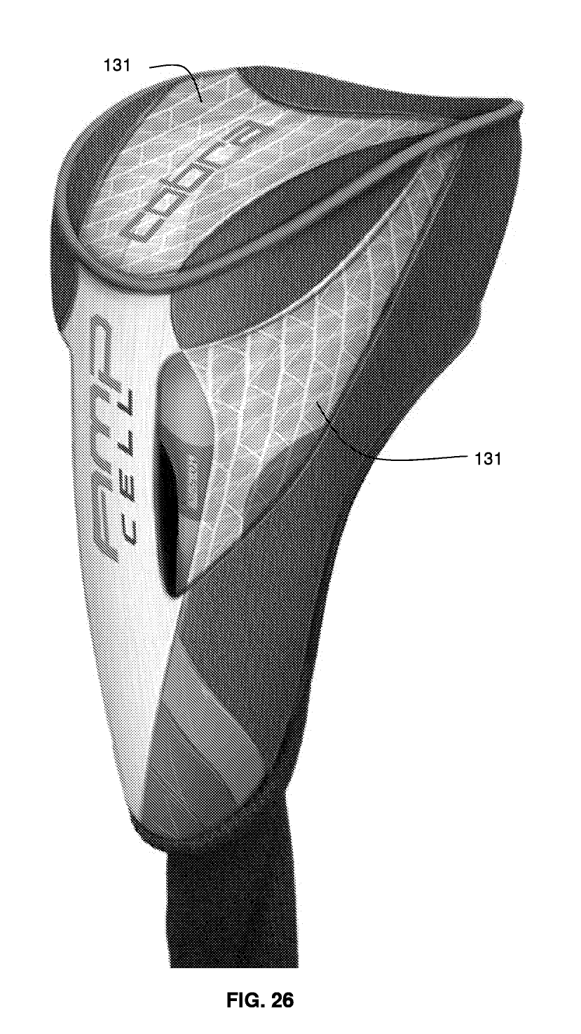

FIG. 25 is an illustration of a cover with an opaque panel insert 137 according to certain embodiments of the invention and FIG. 26 is an illustration of a cover with a see-through panel 131 adjacent to a void 115 to provide an expanded viewing area according to certain embodiments of the invention. As can be understood by studying FIGS. 25 and 26, a cover of the invention can have any of a variety of colorful or decorative finishes, including, for example, a whimsical color pattern, a faux leather finish, a cell-patterned surface, clear panels, translucent panels (any surface of which may be textured or smooth). Further, since a cover according to the invention can be provided to reveal a portion of a covered club head, such covers provide a natural place to locate branding information, graphics, or other indicia that complement the appearance of a club head or draw attention to it.

A functional accessory on a golf club head cover can include any of a variety of tools, displays, and novelties, including utilities that provide valuable service to a serious professional as well as whimsical novelties that bring pleasure and unexpected delight to a golfer. One insight of the invention includes the view that enjoyment will be brought to people through their being encouraged to discover the joy of golf. Golf can be made more appealing to newcomers, and newcomers can be encouraged to see the sport as accessible, by providing tools, gear, and accessories that embody a fun and playful spirit and that communicate inspiring sentiments.

A newcomer to golf, for example, can be encouraged to pick up and play a well-designed club by presenting the club in a club head cover that appears fun; that has intrinsic visual, auditory, and tactile interest; and that communicates a positive message. Accordingly, the invention provides a cover for a golf club that includes a fun, interest-stimulating accessory.

In certain embodiments, an encouraging or inspiring sentiment is communicated to a golfer by a message display on a head cover. For example, a head cover can include a hanging plastic tag with an opening dimensioned to receive a rectangle of paper or cardboard, which can be shipped with a sheet of pre-selected messages, each on a perforated rectangle dimensioned to fit into the tag, or can be shipped with blanks A hang tag can have novelty shapes and can include a message (see, e.g., heart-shaped tag in U.S. Pat. No. 6,202,335, the contents of which are incorporated by reference hereby in their entirety).

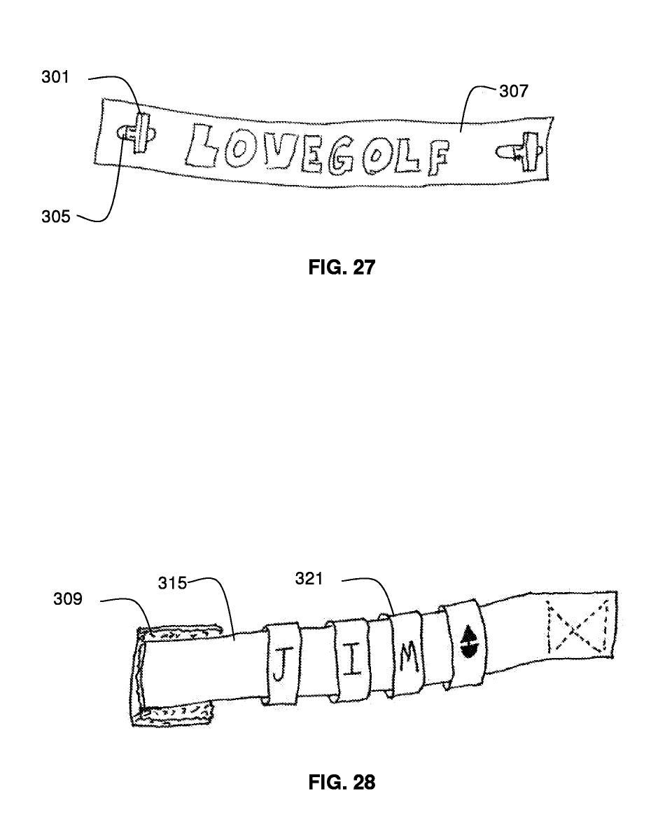

As shown in FIG. 27, in certain embodiments, a head cover includes one or more of stud 301 (e.g., plastic or metal) and is sold with a strip 307 (e.g., plastic or fabric), or a set of strips, with one or more of a corresponding hole 305. Each strip 307 has a message printed on it, and a user can removably mount a strip on the head cover to display a message that comports with their mood. Each stud 201 can have a T-shaped head, and each corresponding hole 305 in strip 307 can be elongated oval (optionally with a grommet) that fits over the T-shaped head of stud 301 in one direction, and can then be rotated to secure the strip in place (e.g., the strip can be flexible, such as fabric, allowing each end to be rotated independently). Removable portions are discussed in U.S. Pat. No. 5,852,829 (the contents of which are hereby incorporated by reference in their entirety).

In certain embodiments, changeable messages are provided on fabric panels that can be removably attached, entirely or partially, through the use of snaps, hook-and-loop fasteners such as those sold under the trademark VELCRO by Velcro USA Inc. (Manchester, N.H.), or similar (see, e.g., U.S. Pub. 2003/0172430, the contents of which are hereby incorporated by reference in their entirety).

In certain embodiments, a club head cover is provided with a set of pre-printed hang tags or blanks that can be written on (e.g., with a permanent marker sold under the trademark SHARPIE) and fastened to the cover with a filament, for example, using a tag attacher tool. Tags and attachment tools are discussed in U.S. Pub. 2005/0178037, the contents of which are hereby incorporated by reference in their entirety.

As shown in FIG. 28, a cover can have a band 315 (e.g., fabric or flexible plastic, for example, in a strap-shape) fastened to a surface at one end and detachably fastened at another end (e.g., by hook-and-loop fasteners 309 or see fastener 135 in FIG. 24). The cover can be provided with one or more of an exchangeable closed loop member 321 that are slidably removable from the band, and each closed loop member 321 can include a pre-printed or consumer-written message on it. In this way, a golfer can display a customized message on the cover. Removable closed loop members are discussed in U.S. Pat. No. 6,880,364, the contents of which are hereby incorporated by reference in their entirety. A changeable message can also be displayed in an electronic display, for example, as discussed in U.S. Pub. 2010/0313334, the contents of which are hereby incorporated by reference in their entirety.

In certain embodiments, a club head cover includes a substantially planar pocket with a see-through panel, for example, as described in U.S. Pat. No. 6,231,233, the contents of which are hereby incorporated by reference in their entirety. A slogan can be provided on a card or panel (e.g., cardboard, plastic, white-board material, etc.) that can be slipped into the planar pocket, thus allowing a golfer to display a changeable message.

A tag or panel can include a humorous reminder, inspirational message, slogan, or similar. Using mechanisms such as those described above, the invention provides a club head cover that bears a message that can be changed by the consumer. The message panel can be publically displayed on an outside of the cover, can be kept personally on an inside of the cover, or can be retractable. In certain embodiments, a message is on a fabric tag that can hang down from within the cover to display a message, and can also be coiled up and snapped or fastened entirely within a cover. Changeable messages are discussed in U.S. Pat. No. 6,311,332; U.S. Pat. No. 4,918,758; U.S. Pub. 2004/0194363; U.S. Pub. 2004/0026280; and U.S. Pub. 2003/0172430, the contents of which are hereby incorporated by reference in their entirety.

In certain embodiments, the invention provides a cover for a golf club that communicates fun and visual interest through color change. A portion of, or all of, a head cover can be provided that changes color by including a color-changing material such as, for example, a photochromic or thermochromic material. Use of a photochromic material provides a head cover that changes color when brought from relative shade into bright sunlight, for example. A head cover for a golf club is a particularly good place to include a color-changing material. Some golfers may see color-changing materials as not reflecting a serious attitude and thus they may be resistant to purchasing an actual playing piece such as a driver, or even a grip for a golf club, that includes a color-changing material. Some golfers may like color-changing materials but perceive that a golf club that includes a color-changing material was designed with fun as a priority over playability. Thus, a head cover is a good place to include such material.

In certain embodiments, all or a portion of a club head cover can comprise a photochromic material. The term “photochromic” generally refers to a reversible change of color under exposure to light, for example by a chromene or a silver halide salt. For example, in some embodiments, the head cover can comprise a crown portion that darkens when exposed to light, for example, to make a different logo appear under different lighting conditions. Photochromic materials are discussed in U.S. Pat. No. 5,843,548; U.S. Pub. 2007/0054594; and U.S. Pub. 2006/0147708; the contents of each of which are hereby incorporated by reference in their entirety.

In certain embodiments, all or a portion of a club head cover comprises a thermochromic material. Thermochromic materials, generally, include those that change color in a temperature sensitive manner. Thermochromic material can include a semi-solid liquid crystal mixture applied as a thin film. Such materials are discussed in U.S. Pat. No. 4,681,791; U.S. Pat. No. 4,642,250; U.S. Pub. 2010/0248852; U.S. Pub. 2009/0046760; and U.S. Pub. 2007/0252115, the contents of each of which are incorporated by reference herein in their entirety for all purposes.

A club head cover according to certain embodiments of the invention includes an audio device that can deliver a slogan, song, or other audio clip. In certain embodiments, an audio device is provided in which a consumer can record his or her own audio sound and play that sound back at the push of a button. The audio device can be incorporated into layers of the material of the club head cover or mounted on a surface, for example, in its own plastic housing. An audio device in a head cover can be a single or multi-use recordable electronic device or chip coupled to a power source such as a small battery and a small speaker from which a recording is played and can be heard by a golfer. Examples of similar technology are used in greeting cards which can be provided with pre-recorded greetings or audio information such as music.

An audio device in a head cover can include a writable, electronic storage device (e.g., a recordable chip, small flash memory device) coupled to an activation device such as a button. In certain embodiments, the recordable chip is connected either directly or indirectly to a cable or jack, which allows the chip to be connected to an electronic device such as a computer, CD player, MP3 player, smart-phone or other similar processing device. The cable is optionally supplied as an accessory with the head cover and is removable from the device.

In another embodiment, the chip may be provided as part of a circuit that is equipped with a wireless receiver, such as a blue tooth receiver or the like, to enable an electronic device such as a computer, CD player, MP3 player, smart-phone or other similar processing device to transmit user recorded or assembled audio information wirelessly to the chip for later playback. The audio device permits a user to select one or more prerecorded music, voice or sound files which the user himself or herself has recorded or which the user has downloaded and stored on the audio device. The user may select a single file or the user may combine together multiple files.

In this configuration, the chip functions within the audio device as a plug-and-play storage device that allows a user to select a file or files and transfer them from, for example, a computer or phone, to the recordable chip using the supplied cable or wirelessly. The cable may be a reusable cable such as a USB, firewire, serial or other currently accepted standard connectable data communication cable or alternatively may be a standard stereo mini plug cable. Sound playing devices are described in U.S. Pat. No. 6,330,427; U.S. Pat. No. 4,840,371; and U.S. Pub. 2011/0088143, the contents of each of which are incorporated by reference herein in their entirety.

In certain embodiments, an audio device is included that mimics or functions as a novelty musical instrument. For example, a head cover can include a keyboard mimicking a portion of a piano keyboard and each key can be configured to play a tone corresponding to a piano key. A functional keyboard disposed on a club head cover gives a musical golfer something to do while they wait for their turn to make a shot. The golfer may entertain and delight the other golfers on the course. In certain embodiments, a club head cover includes touch sensitive keys that are configured to play 8 different notes (e.g., do re mi fa so la ti do). A keyboard audio device can include a memory chip, an on/off switch, operable keys, and an audio output mechanism such as a speaker or a jack (e.g., mini-plug).

In certain aspects, the invention provides a head cover all or a portion of which includes electroluminescent (EL) technology. An EL material in a head cover generally includes a semiconductor material in, for example, a thin film or a powder form and a source of electricity such as a battery or photovoltaic cell. Different EL materials can be included to provide different colors such as, for example, zinc sulfide doped with copper to provide green; zinc sulfide doped with silver to provide blue; or zinc sulfide doped with manganese to provide orange-red. A head cover can include an elongated light source, such as an electro-luminescent wire. One such electro-luminescent wire is commercially available from Solution Industries (Cypress, Tex.) under the Trademark FLEXWIRE. Another such electro-luminescent wire is commercially available from ELAM Electro-luminescent Industries Ltd. (Jerusalem, Israel) under the Trademark LYTEC. Another suitable electro-luminescent light source is an electroluminescent strip, such as that commercially available from E-Light Technologies Inc. (Stafford, Conn.). An EL material portion can be a flat material, such as a narrow strip or a patch that includes an EL material along a flat side. Suitable EL materials are discussed in U.S. Pat. No. 6,116,745; U.S. Pat. No. 5,479,325; U.S. Pub. 2011/0025195; U.S. Pub. 2010/0232143; and U.S. Pub. 2008/0084686, the contents of each of which are incorporated by reference herein in their entirety.

In certain aspects, a head cover brings joy and delight to the game of golf by including a fun and pleasurable novelty accessory in the form of a squirt gun. A squirt gun can be included in a squeezable bladder embodiment, a trigger and pump in reservoir embodiment, or in a high power (e.g., compressed air) embodiment. In a bladder embodiment, a squirt gun includes a deformable plastic bladder approximating the form factor of a gun such as a handgun and having a pinprick hole at the end of a barrel and a pluggable fill hole elsewhere. Squeezing the bladder body forces water out of the pin prick hole in a propelled stream. In a trigger, pump, and reservoir embodiment, each squeeze of a trigger (e.g., plastic trigger slidably mounted on a rail) operates a pump pushing water towards a nozzle in an internal hose, fed by a reservoir (e.g., the body of the squirt gun itself). In a high powered embodiment, the technology of the brand of water gun sold under the trademark SUPER SOAKER by Hasbro (Pawtucket, R.I.) is reproduced in a golf club head cover form factor. A sleeve member of a head cover provides a gun handle and a trigger is disposed at a top of a front-facing portion of the sleeve member. A reservoir is fluidly connected to a pressurizing mechanism, and a “barrel”, or output nozzle is mounted on the head cover, e.g., at the fore-most “snout” portion.

One having ordinary skill in the art will appreciate that any of the accessories and features discussed herein can be included in any accessory used around golfers such as, for example, a golf bag, a display case for golf club (e.g., as used by sales reps at trade shows), a golf hat or visor, or golf shoes.

It is an insight of the invention that a number of aspects of a club head cover can be uniquely selected from wide palette of offerings and that this is well suited to customizing club head covers to a customer's desires. It is a related insight that computer device technology provides a valuable tool for managing the complexity of manufacturing where customized orders are included. Accordingly, the invention provides systems and methods for providing a customized club head cover.

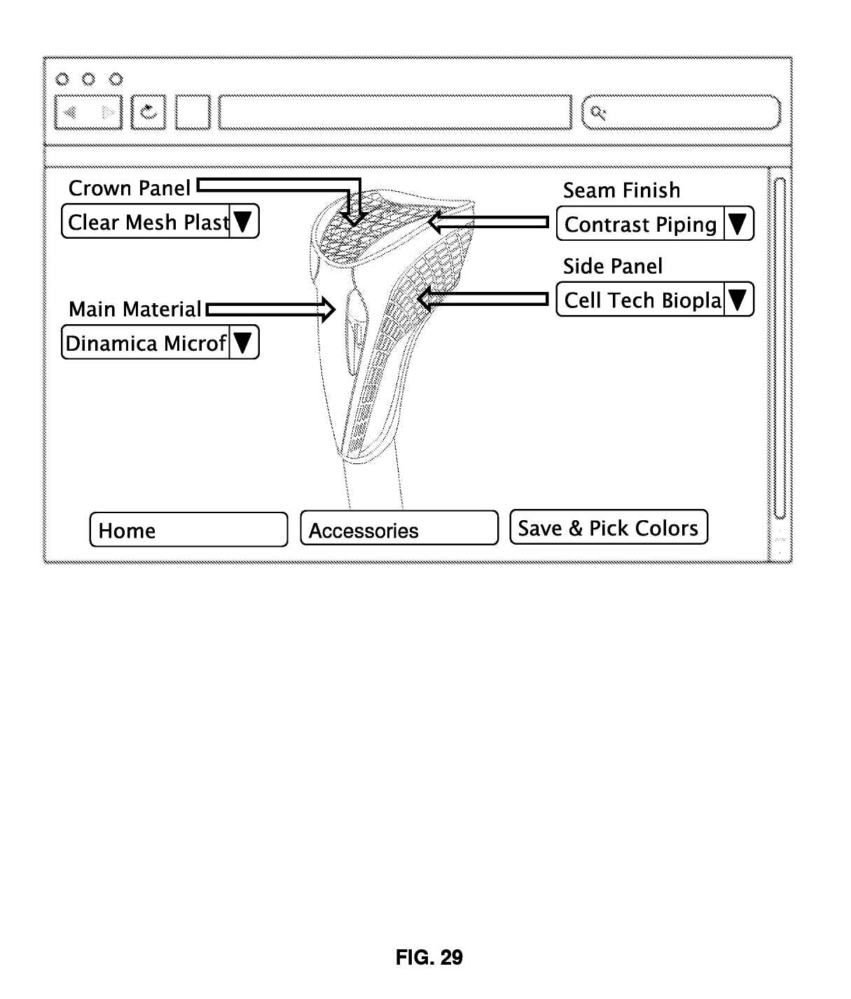

Providing a customized head cover can include offering options for one or more features that are available with a head cover and receiving a selection from a consumer of an option. FIG. 29 depicts a display that can be used to receive a consumer's selection of one or more options for a head cover. As shown in FIG. 29, a consumer could be given a display (e.g., in a web browser as presented via a graphical user interface (GUI)) that includes elements such as pull-down menus for choosing options. Any method of offering options and receiving selections is included, such as, for example, point-and-click selection, keyboard entry, radio buttons, and confirmation of suggested options. A selection of an option can include selecting a given option from a set of possibilities and it can also include selecting whether or not to include a certain feature at all. For example, a consumer can be offered whether or not they would like a functional accessory as part of their head cover and, if they choose so, they can then be offered a list. Options can be offered and selections received for any aspect of a head cover including all of those discussed herein. As indicated in FIG. 29, a consumer could choose a material for a Crown Panel and suitable choices could include: clear mesh panel (e.g., plastic, PVC); a fabric mesh panel (e.g., nylon, cotton, polyester); a clear panel (e.g., PVC); a main material (e.g., leather, microfiber, plastic, faux leather). For main material, a customer can be offered microfiber, plastic, leather, vinyl, neoprene, a list of fabrics by brand, material or color, a fully-waterproofed material or a default. A customer could chose a seam finish (e.g., fused, hidden, matching piping, contrast piping, nylon band). A customer could choose whether to include a side panel of different material (e.g., cell tech bioplastic; hex cell plastic; recycled plastic; bi-layer fabric; plush fabric; fleece material; sandpaper-finish for interesting texture; etc.). Other features a customer could choose options for include overall finish of surface (e.g., waterproofing, matte v. gloss), sleeve material, accessory choice (e.g., bottle opener, iPad pocket, battery housing pocket, removable zippered pouch, inspirational message tag, personalized EL display (e.g., customer's name in light-up writing on surface), customer-uploaded photo printed on surface (e.g., as uploaded digitally via interface similar to one shown in FIG. 27), number of covers (e.g., customer orders entire set or matching covers/sets for whole families), etc.

FIG. 29 generally shows an exemplary display as could be shown on a screen, for example, of a computer or smartphone, discussed in more detail below. In certain embodiments, FIG. 29 represents a display rendered in a web browser (e.g., a web page being displayed by Internet Explorer or Google Chrome). In some embodiments, FIG. 27 depicts a display as rendered by a dedicated computer program such as a mobile app running on a smartphone or similar portable device.

As shown in FIG. 29, receiving customer options can be done via a series of related screens. For example, a customer can choose materials for parts in a first screen, choose optional accessories in another screen, and save their choices and pick colors in another screen. However, in other embodiments, all choices are made on a single screen or a different combination of screens. In certain embodiments, choices are suggested based on inferences made according to computer program rules about a customer's likely preference. For example, if a customer orders a customized golf club in a given color (e.g., a driver with an orange head), a head cover can be shown and suggested with a given matching or complementary color (e.g., orange main material with blue contrast piping, or all green head cover).

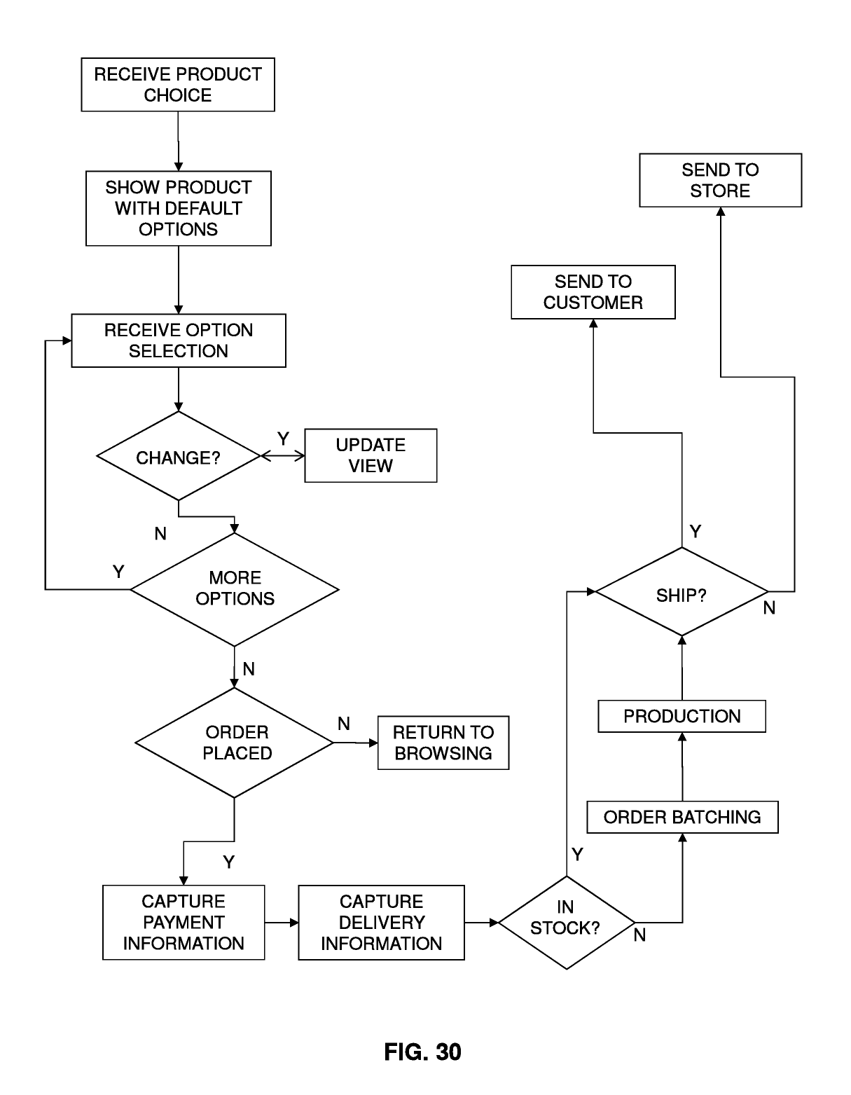

Given the variety of options a customer may choose and the variety of numbers a customer may order, the invention provides methods of receiving and preparing customized orders. FIG. 30 gives a high-level block diagram of steps of a method of providing a customized club head cover according to certain embodiments of the invention. A method of providing a customized head cover according to certain embodiments of the invention can include receiving a customer's choice of a product (e.g., AMP-product line driver head cover) and showing the customer a product example (e.g., FIG. 29). A customer's selections of an option are received and saved in a memory. If the selection reflects a change from what was previously shown, the displayed product view can be updated to show what the customer has chosen. This can be repeated for as many features as are customizable or as many features as the customer chooses to select options for.

If the customer ends up not placing an order, they can be returned to browsing (e.g., shown a web page home screen or another product screen). Their choices can be saved and displayed to them at a later web page visit.

If the customer places an order, methods of the invention include capturing information from the customer about how they will pay for the product and how they will receive it. For example, a customer can provide a credit card number over a computer network (e.g., by typing into a payment web page), and then choose shipping by expedited mail and provide their home address. Or, alternatively, a customer can indicate that they wish to use a corporate account (e.g., they are purchasing a gross of head covers that are printed with a corporate logo which they have uploaded an image file such as a TIFF) and they can specify delivery to some site. A customer can also choose in-store pickup. In certain embodiments, a method of providing a customized club head is operable in conjunction with a special event, and methods include capturing delivery information about providing the covers at the special event. For example, if Acme Golf Co is sponsoring and staffing a booth at Corporate Inc.'s charity fund-raiser, Acme Golf Co can collect information from a person at Corporate Inc. about a customized head cover (e.g., as a promotional item or prize) via methods of the invention, and Acme Golf Co can bring the head cover items to the booth at the charity fund-raiser.

After delivery information is captured, it is determined whether the ordered item is already in stock, as-ordered. If it is, the ordered item is shipped or prepared for delivery according to the customer's delivery information. If the ordered item is not in stock, the order is batched.

Methods of the invention include organizing sets of orders for efficient production. A computer program, executed by a processor, can make reference to information about production facilities to organize a plurality of different orders and to coordinate production instructions so that production facilities include minimal down-time while components or parts are “switched out”. For example, if regular production is scheduled for ten gross of orange head covers and ten gross of red head covers, and customized orders have been placed for one orange head cover, one red head cover, one blue head cover, and one black head cover, then order batching can include listing the order, for example, in the following order: ten gross orange; one orange; ten gross red; one red; one blue; and one black.

Order batching further includes scheduling production of individual batches, where a batch is a sub-set of all orders identified by a computer executing program instructions according to production criteria. Batches may be scheduled according to information about production times, steps, complexity, or interrelationships involved. For example, if a bottle opener is required to be added to a head cover at an assembly workstation where a main body of a head cover is stitched together, while a smartphone pocket is added to a head cover at a dedicated separate workstation and can only be added after a main body is assembled, then a batch can be prepared that is all head covers with a bottle opener batched with all head covers overall, while a separate batch is prepared that includes all head covers in which a customer has ordered a smart phone pocket. Then, the second batch can be routed to the main assembly work station first, for example, to leave additional time for adding the smart phone pocket to that batch while the other batch is at the main assembly workstation so that the entire set of batches is completed at the same time.

After order batching, order information (e.g., info regarding batches, production schedules, and individual orders of head covers) is transmitted to a production system or facility, and the ordered head covers are produced.

After production, the head covers are sent. If a customer has ordered a head cover to be shipped to their home, the cover is sent to the customer. If a customer has requested in-store pickup, the head cover is sent to the store. If a customer has requested another delivery option, it is so initiated.

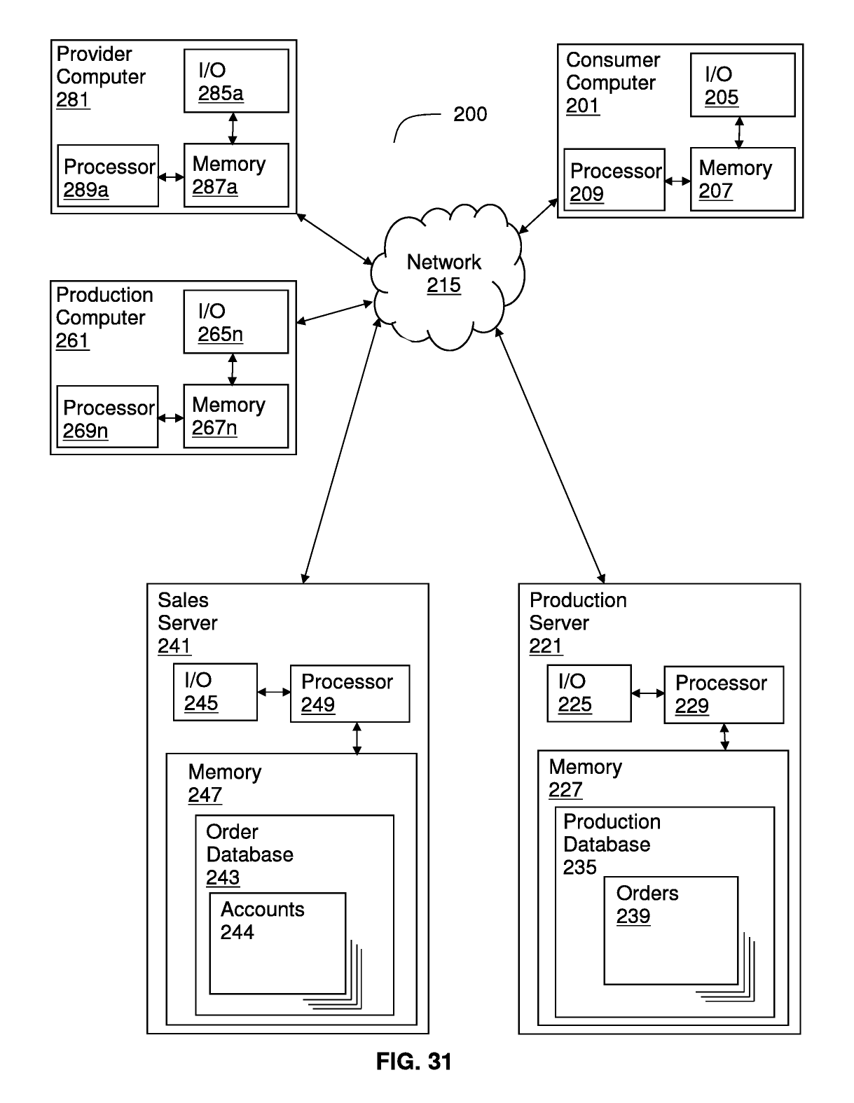

The invention provides systems suitable for implementing methods of providing a customized head cover including the foregoing methods. FIG. 31 shows components in an exemplary system for providing a customized club head cover. As shown in FIG. 31, system 200 generally includes one or more computer, communicably coupled via network 215. Systems and methods of the invention may generally be implemented through the use of one or more computer such as any combination of a provider computer 281, a production computer 261, and a consumer computer 201 along with, for example, a sales server 241 and a production server 221. A computer generally includes a processor (e.g., 209, 289, 269, 249, 229) operably coupled to a memory (e.g., 207, 287, 267, 247, 227) and configured to send or receive information via input-output device (e.g., 205, 285, 265, 245, 225).

One of skill in the art will recognize that a processor may be provided by one or more processors including, for example, one or more of a single core or multi-core processor (e.g., AMD Phenom II X2, Intel Core Duo, AMD Phenom II X4, Intel Core i5, Intel Core i& Extreme Edition 980X, or Intel Xeon E7-2820). In certain embodiments, any of consumer computer 201, provider computer 281, production computer 261 may be a notebook or desktop computer sold by Apple (Cupertino, Calif.) or a desktop, laptop, or similar PC-compatible computer such as a Dell Latitude E6520 PC laptop available from Dell Inc. (Round Rock, Tex.). Such a computer will typically include a suitable operating system such as, for example, Windows 7, Windows 8, Windows XP, all from Microsoft (Redmond, Wash.), OS X from Apple (Cupertino, Calif.), or Ubuntu Linux from Canonical Group Limited (London, UK). In some embodiments, any of consumer computer 201, provider computer 281, production computer 261 may be a tablet or smart-phone form factor device and processor 281 can be provided by, for example, an ARM-based system-on-a-chip (SoC) processor such as the 1.2 GHz dual-core Exynos SoC processor from Samsung Electronics, (Samsung Town, Seoul, South Korea).

In some embodiments, either of sales server 241 or production server 221 can be a Hitachi Compute Blade 500 computer device sold by Hitachi Data Systems (Santa Clara, Calif.). Either of processor 249 or processor 229 can be, for example, a E5-2600 processor sold under the trademark Xeon by Intel Corporation (Santa Clara, Calif.).

Input-output devices generally includes one or a combination of monitor, keyboard, mouse, data jack (e.g., Ethernet port, modem jack, HDMI port, mini-HDMI port, USB port), Wi-Fi card, touchscreen (e.g., CRT, LCD, LED, AMOLED, Super AMOLED), pointing device, trackpad, microphone, speaker, light (e.g., LED), or light/image projection device.

In certain embodiments, a consumer's selection of options is received via the consumer's use of consumer computer 201 and the selection is received at sales server 241 and stored in memory 247. Sales server 241 uses a network card for input/output 245 to received data. Sales server 241 maintains order database 243 which may include accounts 244 where consumer information is stored (e.g., for payment and delivery information).

After orders are received and ready for production, digital files can be transferred via input/output 245 from sales server 241 to production server 221 via input/output 225, which may also be a network card or other data transfer mechanism. Order information (e.g., orders 239) is stored in production database 235 in memory 227. Processor 229 executes computer program instructions stored in memory 229 to perform order batching and to initiate production.

A production facility may be equipped with a production computer 261 which either automatically coordinates the operation of machines or provides information to production employees, e.g., via input/output 265, which could include, for example, a monitor or laser printer.

Many of the steps and functions described herein can be planned or coordinated by a provider personnel using provider computer 281. For example, engineers or sales personnel can prepare and upload information (e.g., digital files such as in a comma-separated values (CSV) format) that, for example, lists options for features for consumer selection. That is, in certain embodiments, provider personnel use provider computer 281 to “set up” what options are available, for example, within a display such as the one shown in FIG. 29. Such uploaded information may be saved in memory 247 on sales server 241 and can be used, for example, by processor 249 to cause a display to be rendered such as that shown in FIG. 27 on input/output 205 on consumer computer 201. Input/output 205 can include a monitor displaying a view of a web browser. A customer's selection of options can be stored in one of accounts 244 in order database 243 by writing a file in memory 247.

A memory generally refers to one or more storage devices for storing data or carrying information, e.g., semiconductor, magnetic, magneto-optical disks, or optical disks. Information carriers for a memory suitable for embodying computer program instructions and data include any suitable form of memory that is tangible, non-transitory, non-volatile, or a combination thereof. In certain embodiments, a device of the invention includes a tangible, non-transitory computer readable medium for memory. Exemplary devices for use as memory include semiconductor memory devices, (e.g., EPROM, EEPROM, solid state drive (SSD), and flash memory devices e.g., SD, micro SD, SDXC, SDIO, SDHC cards); magnetic disks, (e.g., internal hard disks or removable disks); magneto-optical disks; and optical disks (e.g., CD and DVD disks). The processor and the memory can be supplemented by, or incorporated in, special purpose logic circuitry.

The subject matter described herein can be implemented in a computing system that includes a back-end component (e.g., sales server 241 or production server 221), a middleware component (e.g., an application server or sales sever 241), or a front-end component (e.g., consumer computer 201 having a graphical user interface or a web browser through which a user can interact with an implementation of the subject matter described herein), or any combination of such back-end, middleware, and front-end components. The components of the system can be interconnected through network 215 by any form or medium of digital data communication, e.g., a communication network. Examples of communication networks include cell network (e.g., 3G or 4G), a local area network (LAN), and a wide area network (WAN), e.g., the Internet.

The subject matter described herein can be implemented as one or more computer program products, such as one or more computer programs tangibly embodied in an information carrier (e.g., in a non-transitory computer-readable medium) for execution by, or to control the operation of, data processing apparatus (e.g., a programmable processor, a computer, or multiple computers). A computer program (also known as a program, software, software application, app, macro, or code) can be written in any form of programming language, including compiled or interpreted languages (e.g., C, C++, Perl), and it can be deployed in any form, including as a stand-alone program or as a module, component, subroutine, or other unit suitable for use in a computing environment. Systems and methods of the invention can include instructions written in any suitable programming language known in the art, including, without limitation, C, C++, Perl, Java, ActiveX, HTML5, Visual Basic, or JavaScript. In certain embodiments, systems and methods of the invention are implemented through the use of a mobile app. As used herein, mobile app generally refers to a standalone program capable of being installed or run on a smartphone platform such as Android, iOS, Blackberry OS, Windows 8, Windows Mobile, etc.

Functionality of the invention can be implemented by a mobile app or a software application or computer program in other formats included scripts, shell scripts, and functional modules created in development environments.

A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

A file can be a digital file, for example, stored on a hard drive, SSD, CD, or other tangible, non-transitory medium. A file can be sent from one device to another over network 215 (e.g., as packets being sent between a server and a client, for example, through a Network Interface Card, modem, wireless card, or similar).

Writing a file according to the invention involves transforming a tangible, non-transitory computer-readable medium, for example, by adding, removing, or rearranging particles (e.g., with a net charge or dipole moment into patterns of magnetization by read/write heads), the patterns then representing new collocations of information about objective physical phenomena desired by, and useful to, the user (e.g., a physical arrangement of particles that indicates that a specific Honda Civic is due for a tire rotation on a certain date 18 months in the future). In some embodiments, writing involves a physical transformation of material in tangible, non-transitory computer readable media (e.g., with certain optical properties so that optical read/write devices can then read the new and useful collocation of information, e.g., burning a CD-ROM). In some embodiments, writing a file includes transforming a physical flash memory apparatus such as NAND flash memory device and storing information by transforming physical elements in an array of memory cells made from floating-gate transistors. Methods of writing a file can be invoked manually or automatically by a program or by a save command from software or a write command from a programming language.

As used herein, the word “or” means “and or or”, sometimes seen or referred to as “and/or”, unless indicated otherwise.

Any documents referenced in the disclosure are hereby incorporated herein by reference in their entirety for all purposes. Various modifications of the invention and many further embodiments thereof, in addition to those shown and described herein, will become apparent to those skilled in the art from the full contents of this document, including references to the scientific and patent literature cited herein. The subject matter herein contains important information, exemplification and guidance that can be adapted to the practice of this invention in its various embodiments and equivalents thereof.

What is claimed is:

1. A cover for a golf club comprising:
at least one piece of material shaped to define a head region and materially connected to a first end of a sleeve member, the sleeve member having an opening at a second end, wherein the cover is configured to receive a golf club; and
at least one see-through panel.

2. The cover of claim 1, further comprising a hole through the head region having an area of at least 1 cm².

3. The cover of claim 1, wherein the see-through panel has a textured surface.

4. The cover of claim 1, wherein the see-through panel comprises plastic and the textured surface comprises a repeating pattern.

5. The cover of claim 1, wherein the see-through panel is translucent.

6. The cover of claim 1, further wherein the head region comprises a first material, the sleeve member comprises a second material, the see-through panel comprises a third material, and wherein the cover further comprises an insert panel of a fourth material.

7. The cover of claim 6, wherein a surface of the insert panel comprises a pattern of cells.

8. The cover of claim 7, wherein each cell is a hole through more than about 10% of the thickness of the additional material.

9. The cover of claim 7, wherein each cell is substantially the same shape.

10. The cover of claim 1, further comprising a functional accessory.

11. The cover of claim 10, wherein the functional accessory is storage space.

12. The cover of claim 10, wherein the functional accessory is a bottle opener.

13. The cover of claim 1 wherein the material comprises a recycled plastic microfiber.

14. The cover of claim 1 further comprising a window of transparent material.

15. The cover of claim 14, wherein the see-through panel comprises a translucent material and the window comprises one selected from the list consisting of transparent material, mesh, and web.

16. A cover for a golf club comprising:
material disposed to define a right cheek area, a left cheek area, a crown area, a chin area, a nape area, and a sleeve area;
an opening configured to receive a golf club head-first; and
a panel of see-through material.

17. The cover of claim 16 further wherein the panel of see-through material comprises at least a portion of a crown area of the cover and the panel of see-through material has an area of at least about 3 cm².

18. The cover of claim 16, further wherein the material is inelastic, the sleeve area comprises an elastic material, and the see-through material is plastic.

19. The cover of claim 18, further comprising a panel of opaque plastic material.

20. The cover of claim 19, wherein a surface of the opaque plastic material comprises a pattern.

21. The cover of claim 20, wherein the pattern comprises a series of repeating cells of similar shape.

22. The cover of claim 16, further comprising a functional accessory.

23. The cover of claim 22, wherein the functional accessory is one selected from the list of: a fastener; a storage pocket; a bottle opener; a cigar cutter; a light; a removable pouch; an electronic device; a knife; a multi-tool; and printed matter.

24. A method of providing a customized head cover, the method comprising:
receiving a consumer's selection of an option and storing the selection in a tangible, non-transitory memory;
creating, through the use of a computer processor coupled to the memory, a digital file including information about a head cover including the selected option;
transferring the information to a production site; and
producing a customized head cover including the selected option.

25. The method of claim 24, further comprising:
scheduling, via the processor, production of the customized head cover and at least one batch of other head covers according to information about production facilities.

26. The method of claim 24, further comprising:
storing the consumer's selection in memory after the consumer makes a selection and does not place an order while viewing pages of a web site;
presenting, by the processor, the consumer's selection to the consumer on a different day than the day on which the consumer made the selection; and
receiving the consumer's order for the customized head cover.

27. A cover for a golf club comprising:
at least one piece of material shaped to define a head region and materially connected to a first end of a sleeve member, the sleeve member having an opening at a second end, wherein the cover is configured to receive a golf club; and
an electronic accessory.

28. The cover of claim 27, wherein the electronic accessory is an audio accessory that plays sound.

29. The cover of claim 27, wherein the electronic accessory includes a device that generates light.
